(19) United States
(12) Patent Application Publication
(10) Pub. No.: US 2025/0365707 A1
(43) Pub. Date: Nov. 27, 2025

(54) PAGING MESSAGES USING NETWORK-CONTROLLED REPEATERS

(71) Applicant: QUALCOMM Incorporated, San Diego, CA (US)

(72) Inventors: Sourjya DUTTA, San Diego, CA (US); Kapil GULATI, Belle Mead, NJ (US); Navid ABEDINI, Basking Ridge, NJ (US)

(21) Appl. No.: 18/671,666

(22) Filed: May 22, 2024

(51) Int. Cl. H04W 68/02; H04B 7/06; H04W 8/22; H04W 56/00; H04W 74/0833

(52) U.S. Cl. CPC H04W 68/02; H04B 7/06968; H04W 8/22; H04W 56/0015; H04W 74/0833

(57) ABSTRACT

Methods, systems, and devices for wireless communications are described. The described techniques may enable a network entity to use one or more repeaters to repeat messages to a user equipment (UE). For example, the network entity may configure a set of repeaters to repeat a set of paging messages to the UE via a corresponding set of indirect links between the UE and the network entity. Each repeater may perform a frequency translation on the corresponding paging message. The UE may accordingly receive each paging message via the direct link or via the set of indirect links and may select a link via which to perform a random access channel (RACH) procedure. The repeater may transmit the corresponding paging message via a same time resource as a paging message transmitted via the direct link or via a different time resource.

### FIELD OF TECHNOLOGY

The following relates to wireless communications, including paging messages using network-controlled repeaters (NCRs).

### BACKGROUND

Wireless communications systems are widely deployed to provide various types of communication content such as voice, video, packet data, messaging, broadcast, and so on. These systems may be capable of supporting communication with multiple users by sharing the available system resources (e.g., time, frequency, and power). Examples of such multiple-access systems include fourth generation (4G) systems such as Long Term Evolution (LTE) systems, LTE-Advanced (LTE-A) systems, or LTE-A Pro systems, and fifth generation (5G) systems which may be referred to as New Radio (NR) systems. These systems may employ technologies such as code division multiple access (CDMA), time division multiple access (TDMA), frequency division multiple access (FDMA), orthogonal FDMA (OFDMA), or discrete Fourier transform spread orthogonal frequency division multiplexing (DFT-S-OFDM). A wireless multiple-access communications system may include one or more base stations, each supporting wireless communication for communication devices, which may be known as user equipment (UE).

### SUMMARY

The described techniques relate to improved methods, systems, devices, and apparatuses that support paging messages using network-controlled repeaters (NCRs). For example, the described techniques may enable a network entity to use one or more repeaters (e.g., frequency-translating NCRs (FT-NCRs)) to repeat messages to a user equipment (UE). For example, the network entity may configure a set of repeaters to repeat a set of paging messages (e.g., via beams that are quasi co-located (QCLed) with synchronization signal blocks (SSBs) associated with SSB identifiers (IDs)) to the UE via a corresponding set of indirect links between the UE and the network entity (e.g., a set of links through a set of repeaters). Each repeater may perform a frequency translation on the corresponding paging message and may transmit the paging message to the UE via a different frequency band than a frequency band associated with a direct link to the UE. The UE may accordingly receive each paging message via the direct link or via the set of indirect links and may select a link via which to perform a random access channel (RACH) procedure. In some examples (e.g., if an indirect link frequency is relatively closer to a direct link frequency), the repeater may transmit the corresponding paging message via a same time resource as a paging message transmitted via the direct link. In some examples (e.g., if the repeater is a digital FT-NCR), the repeater may buffer a corresponding paging message and may transmit the corresponding paging message via a different time resource (e.g., a different time resource in a DRX cycle).

A method for wireless communications by a network entity is described. The method may include outputting system information indicating a set of multiple paging occasions, where a first paging occasion of the set of multiple paging occasions is associated with a direct link between the network entity and a UE, and where a second paging occasion of the set of multiple paging occasions is associated with a link between the UE and a repeater, outputting a set of multiple paging messages, each of the set of multiple paging messages associated with a corresponding one of the set of multiple paging occasions, and obtaining a message associated with a RACH procedure based on outputting the set of multiple paging messages.

A network entity for wireless communications is described. The network entity may include one or more memories storing processor executable code, and one or more processors coupled with the one or more memories. The one or more processors may individually or collectively be operable to execute the code to cause the network entity to output system information indicating a set of multiple paging occasions, where a first paging occasion of the set of multiple paging occasions is associated with a direct link between the network entity and a UE, and where a second paging occasion of the set of multiple paging occasions is associated with a link between the UE and a repeater, output a set of multiple paging messages, each of the set of multiple paging messages associated with a corresponding one of the set of multiple paging occasions, and obtain a message associated with a RACH procedure based on outputting the set of multiple paging messages.

Another network entity for wireless communications is described. The network entity may include means for outputting system information indicating a set of multiple paging occasions, where a first paging occasion of the set of multiple paging occasions is associated with a direct link between the network entity and a UE, and where a second paging occasion of the set of multiple paging occasions is associated with a link between the UE and a repeater, means for outputting a set of multiple paging messages, each of the set of multiple paging messages associated with a corresponding one of the set of multiple paging occasions, and means for obtaining a message associated with a RACH procedure based on outputting the set of multiple paging messages.

A non-transitory computer-readable medium storing code for wireless communications is described. The code may include instructions executable by one or more processors to output system information indicating a set of multiple paging occasions, where a first paging occasion of the set of multiple paging occasions is associated with a direct link between the network entity and a UE, and where a second paging occasion of the set of multiple paging occasions is associated with a link between the UE and a repeater, output a set of multiple paging messages, each of the set of multiple paging messages associated with a corresponding one of the set of multiple paging occasions, and obtain a message associated with a RACH procedure based on outputting the set of multiple paging messages.

In some examples of the method, network entities, and non-transitory computer-readable medium described herein, outputting the set of multiple paging messages may include operations, features, means, or instructions for outputting a first paging message to the UE during the first paging occasion via the direct link between the network entity and the UE and outputting a second paging message to the repeater.

Some examples of the method, network entities, and non-transitory computer-readable medium described herein may further include operations, features, means, or instructions for outputting a control message indicating a paging configuration, the paging configuration including an indication of one or more SSBs and one or more paging messages of the set of multiple paging messages for the repeater to repeat, where the one or more paging messages may be associated with the one or more SSBs.

In some examples of the method, network entities, and non-transitory computer-readable medium described herein, outputting the set of multiple paging messages may include operations, features, means, or instructions for outputting a capability request message including a request for buffering capability information associated with the repeater and obtaining a capability message indicating a capability of the repeater to perform buffering in response to the capability request message.

Some examples of the method, network entities, and non-transitory computer-readable medium described herein may further include operations, features, means, or instructions for outputting a control message configuring the repeater to buffer a paging message of the set of multiple paging messages based on the capability of the repeater to perform buffering, where first time resources associated with the first paging occasion do not overlap with second time resources associated with the second paging occasion.

In some examples of the method, network entities, and non-transitory computer-readable medium described herein, outputting the set of multiple paging messages may include operations, features, means, or instructions for outputting a first paging message to the UE during the first paging occasion via the direct link between the network entity and the UE and outputting a second paging message during the second paging occasion during the second paging occasion based on an inability of the repeater to perform buffering, where first time resources associated with the first paging occasion do not overlap with second time resources associated with the second paging occasion.

In some examples of the method, network entities, and non-transitory computer-readable medium described herein, outputting the set of multiple paging messages may include operations, features, means, or instructions for outputting the first paging message via a first set of beams that may be quasi co-located (QCLed) with a first subset of SSBs and outputting the second paging message via a second set of beams that may be QCLed with a second subset of SSBs based on the inability of the repeater to perform buffering.

In some examples of the method, network entities, and non-transitory computer-readable medium described herein, the first paging occasion overlaps in time with the second paging occasion.

A method for wireless communications by a UE is described. The method may include receiving system information indicating a set of multiple paging occasions, where a first paging occasion of the set of multiple paging occasions is associated with a direct link between the UE and a network entity, and where a second paging occasion of the set of multiple paging occasions is associated with a link between the UE and a repeater, receiving one or more paging messages, each of the one or more paging messages associated with a corresponding one of the set of multiple paging occasions, and transmitting a message associated with a RACH procedure based on receiving the one or more paging messages.

A UE for wireless communications is described. The UE may include one or more memories storing processor executable code, and one or more processors coupled with the one or more memories. The one or more processors may individually or collectively be operable to execute the code to cause the UE to receive system information indicating a set of multiple paging occasions, where a first paging occasion of the set of multiple paging occasions is associated with a direct link between the UE and a network entity, and where a second paging occasion of the set of multiple paging occasions is associated with a link between the UE and a repeater, receive one or more paging messages, each of the one or more paging messages associated with a corresponding one of the set of multiple paging occasions, and transmit a message associated with a RACH procedure based on receiving the one or more paging messages.

Another UE for wireless communications is described. The UE may include means for receiving system information indicating a set of multiple paging occasions, where a first paging occasion of the set of multiple paging occasions is associated with a direct link between the UE and a network entity, and where a second paging occasion of the set of multiple paging occasions is associated with a link between the UE and a repeater, means for receiving one or more paging messages, each of the one or more paging messages associated with a corresponding one of the set of multiple paging occasions, and means for transmitting a message associated with a RACH procedure based on receiving the one or more paging messages.

A non-transitory computer-readable medium storing code for wireless communications is described. The code may include instructions executable by one or more processors to receive system information indicating a set of multiple paging occasions, where a first paging occasion of the set of multiple paging occasions is associated with a direct link between the UE and a network entity, and where a second paging occasion of the set of multiple paging occasions is associated with a link between the UE and a repeater, receive one or more paging messages, each of the one or more paging messages associated with a corresponding one of the set of multiple paging occasions, and transmit a message associated with a RACH procedure based on receiving the one or more paging messages.

Some examples of the method, UEs, and non-transitory computer-readable medium described herein may further include operations, features, means, or instructions for receiving a set of multiple SSBs, where receiving the set of multiple SSBs includes receiving one more first SSBs via the direct link between the UE and the network entity and receiving one more second SSBs via the link between the UE and the repeater and performing a set of multiple power measurements associated with each of the set of multiple SSBs, where receiving the one or more paging messages may be based on performing the set of multiple power measurements.

In some examples of the method, UEs, and non-transitory computer-readable medium described herein, receiving the one or more paging messages may include operations, features, means, or instructions for receiving a first paging message via one of the direct link between the UE and the network entity or the link between the UE and the repeater based on the set of multiple power measurements.

Some examples of the method, UEs, and non-transitory computer-readable medium described herein may further include operations, features, means, or instructions for performing a second set of multiple power measurements associated with each of the set of multiple SSBs and selecting one of the direct link between the UE and the network entity or the link between the UE and the repeater based on the second set of multiple power measurements, where receiving the first paging message includes receiving the first paging message via the selected one of the direct link between the UE and the network entity or the link between the UE and the repeater.

In some examples of the method, UEs, and non-transitory computer-readable medium described herein, receiving the one or more paging messages may include operations, features, means, or instructions for receiving a first paging message during the first paging occasion via the direct link between the UE and the network entity and receiving a second paging message during the second paging occasion via the link between the UE and the repeater, where the second paging occasion overlaps in time with the first paging occasion.

In some examples of the method, UEs, and non-transitory computer-readable medium described herein, receiving the one or more paging messages may include operations, features, means, or instructions for receiving the one or more paging messages while the UE may be in an idle state of a discontinuous reception mode of the UE.

In some examples of the method, UEs, and non-transitory computer-readable medium described herein, the first paging occasion overlaps in time with the second paging occasion.

In some examples of the method, UEs, and non-transitory computer-readable medium described herein, the first paging occasion does not overlap in time with the second paging occasion.

A method for wireless communications by a repeater is described. The method may include obtaining a control message indicating a paging configuration, the paging configuration including an indication of one or more SSBs and one or more paging messages associated with the one or more SSBs for the repeater to repeat, obtaining the one or more SSBs and the one or more paging messages, and outputting the one or more SSBs and the one or more paging messages in accordance with the configuration.

A repeater for wireless communications is described. The repeater may include one or more memories storing processor executable code, and one or more processors coupled with the one or more memories. The one or more processors may individually or collectively be operable to execute the code to cause the repeater to obtain a control message indicating a paging configuration, the paging configuration including an indication of one or more SSBs and one or more paging messages associated with the one or more SSBs for the repeater to repeat, obtain the one or more SSBs and the one or more paging messages, and output the one or more SSBs and the one or more paging messages in accordance with the configuration.

Another repeater for wireless communications is described. The repeater may include means for obtaining a control message indicating a paging configuration, the paging configuration including an indication of one or more SSBs and one or more paging messages associated with the one or more SSBs for the repeater to repeat, means for obtaining the one or more SSBs and the one or more paging messages, and means for outputting the one or more SSBs and the one or more paging messages in accordance with the configuration.

A non-transitory computer-readable medium storing code for wireless communications is described. The code may include instructions executable by one or more processors to obtain a control message indicating a paging configuration, the paging configuration including an indication of one or more SSBs and one or more paging messages associated with the one or more SSBs for the repeater to repeat, obtain the one or more SSBs and the one or more paging messages, and output the one or more SSBs and the one or more paging messages in accordance with the configuration.

Some examples of the method, repeaters, and non-transitory computer-readable medium described herein may further include operations, features, means, or instructions for performing a frequency translation on the one or more SSBs and the one or more paging messages in accordance with the configuration and outputting the one or more SSBs and the one or more paging messages via a second frequency band, where obtaining the one or more SSBs and the one or more paging messages includes obtaining the one or more SSBs and the one or more paging messages via a first frequency band that may be different from the second frequency band in accordance with the frequency translation.

Some examples of the method, repeaters, and non-transitory computer-readable medium described herein may further include operations, features, means, or instructions for obtaining a capability request message including a request for buffering capability information associated with the repeater and outputting a capability message indicating a capability of the repeater to perform buffering in response to the capability request message.

In some examples of the method, repeaters, and non-transitory computer-readable medium described herein, the control message indicates for the repeater to buffer the one or more paging messages based on the capability of the repeater to perform buffering.

### BRIEF DESCRIPTION OF THE DRAWINGS

FIG. 1 shows an example of a wireless communications system that supports transmitting paging messages using network-controlled repeaters (NCRs) in accordance with one or more aspects of the present disclosure.

FIG. 2 shows an example of a wireless communications system that supports transmitting paging messages using NCRs in accordance with one or more aspects of the present disclosure.

FIG. 3 shows an example of a timing diagram that supports transmitting paging messages using NCRs in accordance with one or more aspects of the present disclosure.

FIG. 4 shows an example of a process flow that supports transmitting paging messages using NCRs in accordance with one or more aspects of the present disclosure.

FIGS. 5 and 6 show block diagrams of devices that support paging messages using NCRs in accordance with one or more aspects of the present disclosure.

FIG. 7 shows a block diagram of a communications manager that supports transmitting paging messages using NCRs in accordance with one or more aspects of the present disclosure.

FIG. 8 shows a diagram of a system including a device that supports transmitting paging messages using NCRs in accordance with one or more aspects of the present disclosure.

FIGS. 9 and 10 show block diagrams of devices that support paging messages using NCRs in accordance with one or more aspects of the present disclosure.

FIG. 11 shows a block diagram of a communications manager that supports transmitting paging messages using NCRs in accordance with one or more aspects of the present disclosure.

FIG. 12 shows a diagram of a system including a device that supports transmitting paging messages using NCRs in accordance with one or more aspects of the present disclosure.

FIGS. 13 through 17 show flowcharts illustrating methods that support paging messages using NCRs in accordance with one or more aspects of the present disclosure.

### DETAILED DESCRIPTION

In some wireless communication systems, a network entity may transmit one or more paging messages to a user equipment (UE). For example, the UE may receive a set of paging messages via a corresponding set of communication links with the network entity, and may use the paging messages to perform a random access channel (RACH) procedure via a highest quality link of the set of communication links. In some cases, however, the UE may be at a cell edge of a network entity, and a direct link between the UE and the network entity may have a relatively low quality (e.g., due to propagation distance and/or interference from neighboring cells). Additionally, if the UE is operating in a low power or idle mode of a discontinuous reception (DRX) scheme, a power consumption associated with monitoring for the paging messages may depend on a bandwidth over which the UE monitors for and decodes paging messages.

Accordingly, techniques described herein may enable a network entity to use one or more repeaters (e.g., network-controlled repeaters (NCRs), which may be frequency-translating network-controlled repeaters (FT-NCRs)) to repeat (e.g., boost) messages to a UE. For example, the network entity may configure a set of repeaters to repeat a set of paging messages (e.g., via beams that are quasi co-located (QCLed) with synchronization signal blocks (SSBs) associated with SSB identifiers (IDs)) to the UE via a corresponding set of indirect links between the UE and the network entity (e.g., a set of links through a set of repeaters). Each repeater may perform a frequency translation on the corresponding paging message and may transmit the paging message to the UE via a different frequency band than a frequency band associated with a direct link to the UE. The UE may accordingly receive each paging message via the direct link or via the set of indirect links and may select a link via which to perform a RACH procedure.

In some examples (e.g., if an indirect link frequency is relatively closer to a direct link frequency), a repeater may transmit the corresponding paging message via a same time resource as a paging message transmitted via the direct link. Such techniques may allow the UE to receive and decode multiple paging messages simultaneously, which may decrease latency in the wireless communication system. In some examples (e.g., if the repeater is a digital FT-NCR), the repeater may buffer a corresponding paging message and may transmit the corresponding paging message via a different time resource (e.g., a different time resource in a DRX cycle). Accordingly, the UE may monitor a relatively smaller transmission bandwidth at a given time for paging messages, which may decrease power consumption at the UE.

Aspects of the disclosure are initially described in the context of wireless communications systems. Aspects of the disclosure are further illustrated by and described with reference to timing diagrams, process flows, apparatus diagrams, system diagrams, and flowcharts that relate to paging messages using repeaters. Although examples may be described herein in which one or more repeaters are FT-NCRs, it is to be understood that the teachings herein may be applicable to any type of repeater, including non-frequency-translating repeaters and non-network-controlled repeaters.

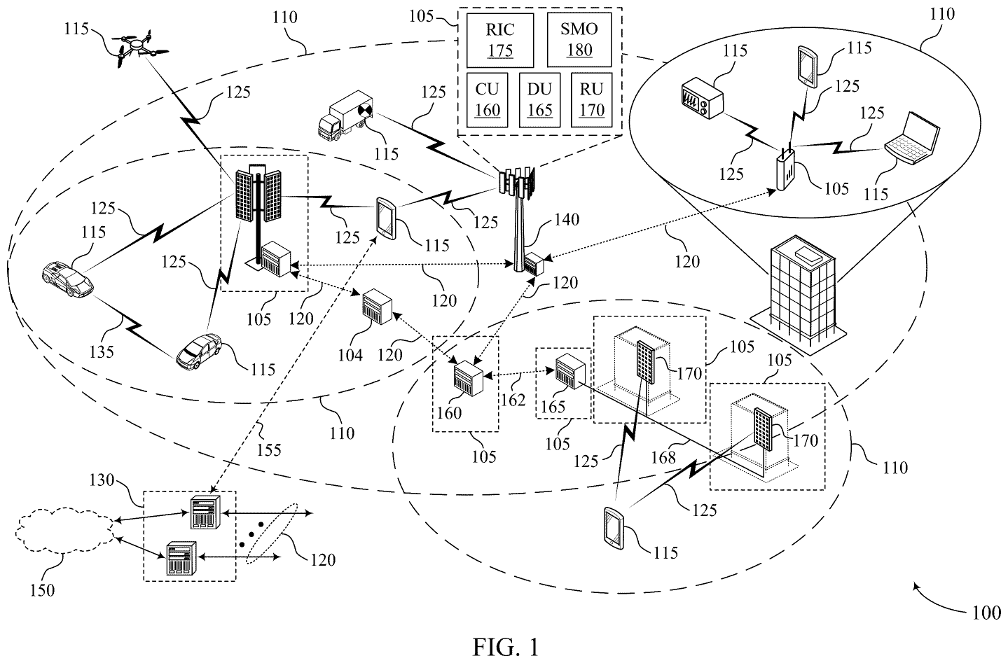

FIG. 1 shows an example of a wireless communications system 100 that supports transmitting paging messages using NCRs in accordance with one or more aspects of the present disclosure. The wireless communications system 100 may include one or more devices, such as one or more network devices (e.g., network entities 105), one or more UEs 115, and a core network 130. In some examples, the wireless communications system 100 may be a Long Term Evolution (LTE) network, an LTE-Advanced (LTE-A) network, an LTE-A Pro network, a New Radio (NR) network, or a network operating in accordance with other systems and radio technologies, including future systems and radio technologies not explicitly mentioned herein.

The network entities 105 may be dispersed throughout a geographic area to form the wireless communications system 100 and may include devices in different forms or having different capabilities. In various examples, a network entity 105 may be referred to as a network element, a mobility element, a radio access network (RAN) node, or network equipment, among other nomenclature. In some examples, network entities 105 and UEs 115 may wirelessly communicate via communication link(s) 125 (e.g., a radio frequency (RF) access link). For example, a network entity 105 may support a coverage area 110 (e.g., a geographic coverage area) over which the UEs 115 and the network entity 105 may establish the communication link(s) 125. The coverage area 110 may be an example of a geographic area over which a network entity 105 and a UE 115 may support the communication of signals according to one or more radio access technologies (RATs).

The UEs 115 may be dispersed throughout a coverage area 110 of the wireless communications system 100, and each UE 115 may be stationary, or mobile, or both at different times. The UEs 115 may be devices in different forms or having different capabilities. Some example UEs 115 are illustrated in FIG. 1. The UEs 115 described herein may be capable of supporting communications with various types of devices in the wireless communications system 100 (e.g., other wireless communication devices, including UEs 115 or network entities 105), as shown in FIG. 1.

As described herein, a node of the wireless communications system 100, which may be referred to as a network node, or a wireless node, may be a network entity 105 (e.g., any network entity described herein), a UE 115 (e.g., any UE described herein), a network controller, an apparatus, a device, a computing system, one or more components, or another suitable processing entity configured to perform any of the techniques described herein. For example, a node may be a UE 115. As another example, a node may be a network entity 105. As another example, a first node may be configured to communicate with a second node or a third node. In one aspect of this example, the first node may be a UE 115, the second node may be a network entity 105, and the third node may be a UE 115. In another aspect of this example, the first node may be a UE 115, the second node may be a network entity 105, and the third node may be a network entity 105. In yet other aspects of this example, the first, second, and third nodes may be different relative to these examples. Similarly, reference to a UE 115, network entity 105, apparatus, device, computing system, or the like may include disclosure of the UE 115, network entity 105, apparatus, device, computing system, or the like being a node. For example, disclosure that a UE 115 is configured to receive information from a network entity 105 also discloses that a first node is configured to receive information from a second node.

In some examples, network entities 105 may communicate with a core network 130, or with one another, or both. For example, network entities 105 may communicate with the core network 130 via backhaul communication link(s) 120 (e.g., in accordance with an S1, N2, N3, or other interface protocol). In some examples, network entities 105 may communicate with one another via backhaul communication link(s) 120 (e.g., in accordance with an X2, Xn, or other interface protocol) either directly (e.g., directly between network entities 105) or indirectly (e.g., via the core network 130). In some examples, network entities 105 may communicate with one another via a midhaul communication link 162 (e.g., in accordance with a midhaul interface protocol) or a fronthaul communication link 168 (e.g., in accordance with a fronthaul interface protocol), or any combination thereof. The backhaul communication link(s) 120, midhaul communication links 162, or fronthaul communication links 168 may be or include one or more wired links (e.g., an electrical link, an optical fiber link) or one or more wireless links (e.g., a radio link, a wireless optical link), among other examples or various combinations thereof. A UE 115 may communicate with the core network 130 via a communication link 155.

One or more of the network entities 105 or network equipment described herein may include or may be referred to as a base station 140 (e.g., a base transceiver station, a radio base station, an NR base station, an access point, a radio transceiver, a NodeB, an eNodeB (eNB), a next-generation NodeB or giga-NodeB (either of which may be referred to as a gNB), a 5G NB, a next-generation eNB (ng-eNB), a Home NodeB, a Home eNodeB, or other suitable terminology). In some examples, a network entity 105 (e.g., a base station 140) may be implemented in an aggregated (e.g., monolithic, standalone) base station architecture, which may be configured to utilize a protocol stack that is physically or logically integrated within one network entity (e.g., a network entity 105 or a single RAN node, such as a base station 140).

In some examples, a network entity 105 may be implemented in a disaggregated architecture (e.g., a disaggregated base station architecture, a disaggregated RAN architecture), which may be configured to utilize a protocol stack that is physically or logically distributed among multiple network entities (e.g., network entities 105), such as an integrated access and backhaul (IAB) network, an open RAN (O-RAN) (e.g., a network configuration sponsored by the O-RAN Alliance), or a virtualized RAN (vRAN) (e.g., a cloud RAN (C-RAN)). For example, a network entity 105 may include one or more of a central unit (CU), such as a CU 160, a distributed unit (DU), such as a DU 165, a radio unit (RU), such as an RU 170, a RAN Intelligent Controller (RIC), such as an RIC 175 (e.g., a Near-Real Time RIC (Near-RT RIC), a Non-Real Time RIC (Non-RT RIC)), a Service Management and Orchestration (SMO) system, such as an SMO system 180, or any combination thereof. An RU 170 may also be referred to as a radio head, a smart radio head, a remote radio head (RRH), a remote radio unit (RRU), or a transmission reception point (TRP). One or more components of the network entities 105 in a disaggregated RAN architecture may be co-located, or one or more components of the network entities 105 may be located in distributed locations (e.g., separate physical locations). In some examples, one or more of the network entities 105 of a disaggregated RAN architecture may be implemented as virtual units (e.g., a virtual CU (VCU), a virtual DU (VDU), a virtual RU (VRU)).

The split of functionality between a CU 160, a DU 165, and an RU 170 is flexible and may support different functionalities depending on which functions (e.g., network layer functions, protocol layer functions, baseband functions, RF functions, or any combinations thereof) are performed at a CU 160, a DU 165, or an RU 170. For example, a functional split of a protocol stack may be employed between a CU 160 and a DU 165 such that the CU 160 may support one or more layers of the protocol stack and the DU 165 may support one or more different layers of the protocol stack. In some examples, the CU 160 may host upper protocol layer (e.g., layer 3 (L3), layer 2 (L2)) functionality and signaling (e.g., Radio Resource Control (RRC), service data adaptation protocol (SDAP), Packet Data Convergence Protocol (PDCP)). The CU 160 (e.g., one or more CUs) may be connected to a DU 165 (e.g., one or more DUs) or an RU 170 (e.g., one or more RUs), or some combination thereof, and the DUs 165, RUs 170, or both may host lower protocol layers, such as layer 1 (L1) (e.g., physical (PHY) layer) or L2 (e.g., radio link control (RLC) layer, medium access control (MAC) layer) functionality and signaling, and may each be at least partially controlled by the CU 160. Additionally, or alternatively, a functional split of the protocol stack may be employed between a DU 165 and an RU 170 such that the DU 165 may support one or more layers of the protocol stack and the RU 170 may support one or more different layers of the protocol stack. The DU 165 may support one or multiple different cells (e.g., via one or multiple different RUs, such as an RU 170). In some cases, a functional split between a CU 160 and a DU 165 or between a DU 165 and an RU 170 may be within a protocol layer (e.g., some functions for a protocol layer may be performed by one of a CU 160, a DU 165, or an RU 170, while other functions of the protocol layer are performed by a different one of the CU 160, the DU 165, or the RU 170). A CU 160 may be functionally split further into CU control plane (CU-CP) and CU user plane (CU-UP) functions. A CU 160 may be connected to a DU 165 via a midhaul communication link 162 (e.g., F1, F1-c, F1-u), and a DU 165 may be connected to an RU 170 via a fronthaul communication link 168 (e.g., open fronthaul (FH) interface). In some examples, a midhaul communication link 162 or a fronthaul communication link 168 may be implemented in accordance with an interface (e.g., a channel) between layers of a protocol stack supported by respective network entities (e.g., one or more of the network entities 105) that are in communication via such communication links.

In some wireless communications systems (e.g., the wireless communications system 100), infrastructure and spectral resources for radio access may support wireless backhaul link capabilities to supplement wired backhaul connections, providing an IAB network architecture (e.g., to a core network 130). In some cases, in an IAB network, one or more of the network entities 105 (e.g., network entities 105 or IAB node(s) 104) may be partially controlled by each other. The IAB node(s) 104 may be referred to as a donor entity or an IAB donor. A DU 165 or an RU 170 may be partially controlled by a CU 160 associated with a network entity 105 or base station 140 (such as a donor network entity or a donor base station). The one or more donor entities (e.g., IAB donors) may be in communication with one or more additional devices (e.g., IAB node(s) 104) via supported access and backhaul links (e.g., backhaul communication link(s) 120). IAB node(s) 104 may include an IAB mobile termination (IAB-MT) controlled (e.g., scheduled) by one or more DUs (e.g., DUs 165) of a coupled IAB donor. An IAB-MT may be equipped with an independent set of antennas for relay of communications with UEs 115 or may share the same antennas (e.g., of an RU 170) of IAB node(s) 104 used for access via the DU 165 of the IAB node(s) 104 (e.g., referred to as virtual IAB-MT (vIAB-MT)). In some examples, the IAB node(s) 104 may include one or more DUs (e.g., DUs 165) that support communication links with additional entities (e.g., IAB node(s) 104, UEs 115) within the relay chain or configuration of the access network (e.g., downstream). In such cases, one or more components of the disaggregated RAN architecture (e.g., the IAB node(s) 104 or components of the IAB node(s) 104) may be configured to operate according to the techniques described herein.

In the case of the techniques described herein applied in the context of a disaggregated RAN architecture, one or more components of the disaggregated RAN architecture may be configured to support test as described herein. For example, some operations described as being performed by a UE 115 or a network entity 105 (e.g., a base station 140) may additionally, or alternatively, be performed by one or more components of the disaggregated RAN architecture (e.g., components such as an IAB node, a DU 165, a CU 160, an RU 170, an RIC 175, an SMO system 180).

A UE 115 may include or may be referred to as a mobile device, a wireless device, a remote device, a handheld device, or a subscriber device, or some other suitable terminology, where the “device” may also be referred to as a unit, a station, a terminal, or a client, among other examples. A UE 115 may also include or may be referred to as a personal electronic device such as a cellular phone, a personal digital assistant (PDA), a tablet computer, a laptop computer, or a personal computer. In some examples, a UE 115 may include or be referred to as a wireless local loop (WLL) station, an Internet of Things (IoT) device, an Internet of Everything (IoE) device, or a machine type communications (MTC) device, among other examples, which may be implemented in various objects such as appliances, vehicles, or meters, among other examples.

The UEs 115 described herein may be able to communicate with various types of devices, such as UEs 115 that may sometimes operate as relays, as well as the network entities 105 and the network equipment including macro eNBs or gNBs, small cell eNBs or gNBs, or relay base stations, among other examples, as shown in FIG. 1.

The UEs 115 and the network entities 105 may wirelessly communicate with one another via the communication link(s) 125 (e.g., one or more access links) using resources associated with one or more carriers. The term “carrier” may refer to a set of RF spectrum resources having a defined PHY layer structure for supporting the communication link(s) 125. For example, a carrier used for the communication link(s) 125 may include a portion of an RF spectrum band (e.g., a bandwidth part (BWP)) that is operated according to one or more PHY layer channels for a given RAT (e.g., LTE, LTE-A, LTE-A Pro, NR). Each PHY layer channel may carry acquisition signaling (e.g., synchronization signals, system information), control signaling that coordinates operation for the carrier, user data, or other signaling. The wireless communications system 100 may support communication with a UE 115 using carrier aggregation or multi-carrier operation. A UE 115 may be configured with multiple downlink component carriers and one or more uplink component carriers according to a carrier aggregation configuration. Carrier aggregation may be used with both frequency division duplexing (FDD) and time division duplexing (TDD) component carriers. Communication between a network entity 105 and other devices may refer to communication between the devices and any portion (e.g., entity, sub-entity) of a network entity 105. For example, the terms “transmitting,” “receiving,” or “communicating,” when referring to a network entity 105, may refer to any portion of a network entity 105 (e.g., a base station 140, a CU 160, a DU 165, a RU 170) of a RAN communicating with another device (e.g., directly or via one or more other network entities, such as one or more of the network entities 105).

In some examples, such as in a carrier aggregation configuration, a carrier may have acquisition signaling or control signaling that coordinates operations for other carriers. A carrier may be associated with a frequency channel (e.g., an evolved universal mobile telecommunication system terrestrial radio access (E-UTRA) absolute RF channel number (EARFCN)) and may be identified according to a channel raster for discovery by the UEs 115. A carrier may be operated in a standalone mode, in which case initial acquisition and connection may be conducted by the UEs 115 via the carrier, or the carrier may be operated in a non-standalone mode, in which case a connection is anchored using a different carrier (e.g., of the same or a different RAT).

The communication link(s) 125 of the wireless communications system 100 may include downlink transmissions (e.g., forward link transmissions) from a network entity 105 to a UE 115, uplink transmissions (e.g., return link transmissions) from a UE 115 to a network entity 105, or both, among other configurations of transmissions. Carriers may carry downlink or uplink communications (e.g., in an FDD mode) or may be configured to carry downlink and uplink communications (e.g., in a TDD mode).

A carrier may be associated with a particular bandwidth of the RF spectrum and, in some examples, the carrier bandwidth may be referred to as a “system bandwidth” of the carrier or the wireless communications system 100. For example, the carrier bandwidth may be one of a set of bandwidths for carriers of a particular RAT (e.g., 1.4, 3, 5, 10, 15, 20, 40, or 80 megahertz (MHz)). Devices of the wireless communications system 100 (e.g., the network entities 105, the UEs 115, or both) may have hardware configurations that support communications using a particular carrier bandwidth or may be configurable to support communications using one of a set of carrier bandwidths. In some examples, the wireless communications system 100 may include network entities 105 or UEs 115 that support concurrent communications using carriers associated with multiple carrier bandwidths. In some examples, each served UE 115 may be configured for operating using portions (e.g., a sub-band, a BWP) or all of a carrier bandwidth.

Signal waveforms transmitted via a carrier may be made up of multiple subcarriers (e.g., using multi-carrier modulation (MCM) techniques such as orthogonal frequency division multiplexing (OFDM) or discrete Fourier transform spread OFDM (DFT-S-OFDM)). In a system employing MCM techniques, a resource element may refer to resources of one symbol period (e.g., a duration of one modulation symbol) and one subcarrier, in which case the symbol period and subcarrier spacing may be inversely related. The quantity of bits carried by each resource element may depend on the modulation scheme (e.g., the order of the modulation scheme, the coding rate of the modulation scheme, or both), such that a relatively higher quantity of resource elements (e.g., in a transmission duration) and a relatively higher order of a modulation scheme may correspond to a relatively higher rate of communication. A wireless communications resource may refer to a combination of an RF spectrum resource, a time resource, and a spatial resource (e.g., a spatial layer, a beam), and the use of multiple spatial resources may increase the data rate or data integrity for communications with a UE 115.

One or more numerologies for a carrier may be supported, and a numerology may include a subcarrier spacing (Δf) and a cyclic prefix. A carrier may be divided into one or more BWPs having the same or different numerologies. In some examples, a UE 115 may be configured with multiple BWPs. In some examples, a single BWP for a carrier may be active at a given time and communications for the UE 115 may be restricted to one or more active BWPs.

The time intervals for the network entities 105 or the UEs 115 may be expressed in multiples of a basic time unit which may, for example, refer to a sampling period of Tₛ=1/(Δfₘₐₓ·N_{f}) seconds, for which Δfₘₐₓ may represent a supported subcarrier spacing, and N_{f} may represent a supported discrete Fourier transform (DFT) size. Time intervals of a communications resource may be organized according to radio frames each having a specified duration (e.g., 10 milliseconds (ms)). Each radio frame may be identified by a system frame number (SFN) (e.g., ranging from 0 to 1023).

Each frame may include multiple consecutively-numbered subframes or slots, and each subframe or slot may have the same duration. In some examples, a frame may be divided (e.g., in the time domain) into subframes, and each subframe may be further divided into a quantity of slots. Alternatively, each frame may include a variable quantity of slots, and the quantity of slots may depend on subcarrier spacing. Each slot may include a quantity of symbol periods (e.g., depending on the length of the cyclic prefix prepended to each symbol period). In some wireless communications systems, such as the wireless communications system 100, a slot may further be divided into multiple mini-slots associated with one or more symbols. Excluding the cyclic prefix, each symbol period may be associated with one or more (e.g., N_{f}) sampling periods. The duration of a symbol period may depend on the subcarrier spacing or frequency band of operation.

A subframe, a slot, a mini-slot, or a symbol may be the smallest scheduling unit (e.g., in the time domain) of the wireless communications system 100 and may be referred to as a transmission time interval (TTI). In some examples, the TTI duration (e.g., a quantity of symbol periods in a TTI) may be variable. Additionally, or alternatively, the smallest scheduling unit of the wireless communications system 100 may be dynamically selected (e.g., in bursts of shortened TTIs (STTIs)).

Physical channels may be multiplexed for communication using a carrier according to various techniques. A physical control channel and a physical data channel may be multiplexed for signaling via a downlink carrier, for example, using one or more of time division multiplexing (TDM) techniques, frequency division multiplexing (FDM) techniques, or hybrid TDM-FDM techniques. A control region (e.g., a control resource set (CORESET)) for a physical control channel may be defined by a set of symbol periods and may extend across the system bandwidth or a subset of the system bandwidth of the carrier. One or more control regions (e.g., CORESETs) may be configured for a set of the UEs 115. For example, one or more of the UEs 115 may monitor or search control regions for control information according to one or more search space sets, and each search space set may include one or multiple control channel candidates in one or more aggregation levels arranged in a cascaded manner. An aggregation level for a control channel candidate may refer to an amount of control channel resources (e.g., control channel elements (CCEs)) associated with encoded information for a control information format having a given payload size. Search space sets may include common search space sets configured for sending control information to UEs 115 (e.g., one or more UEs) or may include UE-specific search space sets for sending control information to a UE 115 (e.g., a specific UE).

A network entity 105 may provide communication coverage via one or more cells, for example a macro cell, a small cell, a hot spot, or other types of cells, or any combination thereof. The term “cell” may refer to a logical communication entity used for communication with a network entity 105 (e.g., using a carrier) and may be associated with an identifier for distinguishing neighboring cells (e.g., a physical cell identifier (PCID), a virtual cell identifier (VCID)). In some examples, a cell also may refer to a coverage area 110 or a portion of a coverage area 110 (e.g., a sector) over which the logical communication entity operates. Such cells may range from smaller areas (e.g., a structure, a subset of structure) to larger areas depending on various factors such as the capabilities of the network entity 105. For example, a cell may be or include a building, a subset of a building, or exterior spaces between or overlapping with coverage areas 110, among other examples.

A macro cell generally covers a relatively large geographic area (e.g., several kilometers in radius) and may allow unrestricted access by the UEs 115 with service subscriptions with the network provider supporting the macro cell. A small cell may be associated with a network entity 105 operating with lower power (e.g., a base station 140 operating with lower power) relative to a macro cell, and a small cell may operate using the same or different (e.g., licensed, unlicensed) frequency bands as macro cells. Small cells may provide unrestricted access to the UEs 115 with service subscriptions with the network provider or may provide restricted access to the UEs 115 having an association with the small cell (e.g., the UEs 115 in a closed subscriber group (CSG), the UEs 115 associated with users in a home or office). A network entity 105 may support one or more cells and may also support communications via the one or more cells using one or multiple component carriers.

In some examples, a carrier may support multiple cells, and different cells may be configured according to different protocol types (e.g., MTC, narrowband IoT (NB-IoT), enhanced mobile broadband (eMBB)) that may provide access for different types of devices.

In some examples, a network entity 105 (e.g., a base station 140, an RU 170) may be movable and therefore provide communication coverage for a moving coverage area, such as the coverage area 110. In some examples, coverage areas 110 (e.g., different coverage areas) associated with different technologies may overlap, but the coverage areas 110 (e.g., different coverage areas) may be supported by the same network entity (e.g., a network entity 105). In some other examples, overlapping coverage areas, such as a coverage area 110, associated with different technologies may be supported by different network entities (e.g., the network entities 105). The wireless communications system 100 may include, for example, a heterogeneous network in which different types of the network entities 105 support communications for coverage areas 110 (e.g., different coverage areas) using the same or different RATs.

The wireless communications system 100 may support synchronous or asynchronous operation. For synchronous operation, network entities 105 (e.g., base stations 140) may have similar frame timings, and transmissions from different network entities (e.g., different ones of the network entities 105) may be approximately aligned in time. For asynchronous operation, network entities 105 may have different frame timings, and transmissions from different network entities (e.g., different ones of network entities 105) may, in some examples, not be aligned in time. The techniques described herein may be used for either synchronous or asynchronous operations.

Some UEs 115 may be configured to employ operating modes that reduce power consumption, such as half-duplex communications (e.g., a mode that supports one-way communication via transmission or reception, but not transmission and reception concurrently). In some examples, half-duplex communications may be performed at a reduced peak rate. Other power conservation techniques for the UEs 115 may include entering a power saving deep sleep mode when not engaging in active communications, operating using a limited bandwidth (e.g., according to narrowband communications), or a combination of these techniques. For example, some UEs 115 may be configured for operation using a narrowband protocol type that is associated with a defined portion or range (e.g., set of subcarriers or resource blocks (RBs)) within a carrier, within a guard-band of a carrier, or outside of a carrier. In some examples, UEs 115 may operate in a discontinuous reception (DRX) mode in which the UEs 115 may be idle for one or more durations (e.g., with one or more hardware components powered down) and active for one or more durations (e.g., monitoring for messages).

The wireless communications system 100 may be configured to support ultra-reliable communications or low-latency communications, or various combinations thereof. For example, the wireless communications system 100 may be configured to support ultra-reliable low-latency communications (URLLC). The UEs 115 may be designed to support ultra-reliable, low-latency, or critical functions. Ultra-reliable communications may include private communication or group communication and may be supported by one or more services such as push-to-talk, video, or data. Support for ultra-reliable, low-latency functions may include prioritization of services, and such services may be used for public safety or general commercial applications. The terms ultra-reliable, low-latency, and ultra-reliable low-latency may be used interchangeably herein.

In some examples, a UE 115 may be configured to support communicating directly with other UEs (e.g., one or more of the UEs 115) via a device-to-device (D2D) communication link, such as a D2D communication link 135 (e.g., in accordance with a peer-to-peer (P2P), D2D, or sidelink protocol). In some examples, one or more UEs 115 of a group that are performing D2D communications may be within the coverage area 110 of a network entity 105 (e.g., a base station 140, an RU 170), which may support aspects of such D2D communications being configured by (e.g., scheduled by) the network entity 105. In some examples, one or more UEs 115 of such a group may be outside the coverage area 110 of a network entity 105 or may be otherwise unable to or not configured to receive transmissions from a network entity 105. In some examples, groups of the UEs 115 communicating via D2D communications may support a one-to-many (1:M) system in which each UE 115 transmits to one or more of the UEs 115 in the group. In some examples, a network entity 105 may facilitate the scheduling of resources for D2D communications. In some other examples, D2D communications may be carried out between the UEs 115 without an involvement of a network entity 105.

The core network 130 may provide user authentication, access authorization, tracking, Internet Protocol (IP) connectivity, and other access, routing, or mobility functions. The core network 130 may be an evolved packet core (EPC) or 5G core (5GC), which may include at least one control plane entity that manages access and mobility (e.g., a mobility management entity (MME), an access and mobility management function (AMF)) and at least one user plane entity that routes packets or interconnects to external networks (e.g., a serving gateway (S-GW), a Packet Data Network (PDN) gateway (P-GW), or a user plane function (UPF)). The control plane entity may manage non-access stratum (NAS) functions such as mobility, authentication, and bearer management for the UEs 115 served by the network entities 105 (e.g., base stations 140) associated with the core network 130. User IP packets may be transferred through the user plane entity, which may provide IP address allocation as well as other functions. The user plane entity may be connected to IP services 150 for one or more network operators. The IP services 150 may include access to the Internet, Intranet(s), an IP Multimedia Subsystem (IMS), or a Packet-Switched Streaming Service.

The wireless communications system 100 may operate using one or more frequency bands, which may be in the range of 300 megahertz (MHz) to 300 gigahertz (GHz). Generally, the region from 300 MHz to 3 GHz is known as the ultra-high frequency (UHF) region or decimeter band because the wavelengths range from approximately one decimeter to one meter in length. UHF waves may be blocked or redirected by buildings and environmental features, which may be referred to as clusters, but the waves may penetrate structures sufficiently for a macro cell to provide service to the UEs 115 located indoors. Communications using UHF waves may be associated with smaller antennas and shorter ranges (e.g., less than one hundred kilometers) compared to communications using the smaller frequencies and longer waves of the high frequency (HF) or very high frequency (VHF) portion of the spectrum below 300 MHz.

The wireless communications system 100 may also operate using a super high frequency (SHF) region, which may be in the range of 3 GHz to 30 GHz, also known as the centimeter band, or using an extremely high frequency (EHF) region of the spectrum (e.g., from 30 GHz to 300 GHz), also known as the millimeter band. In some examples, the wireless communications system 100 may support millimeter wave (mmW) communications between the UEs 115 and the network entities 105 (e.g., base stations 140, RUs 170), and EHF antennas of the respective devices may be smaller and more closely spaced than UHF antennas. In some examples, such techniques may facilitate using antenna arrays within a device. The propagation of EHF transmissions, however, may be subject to even greater attenuation and shorter range than SHF or UHF transmissions. The techniques disclosed herein may be employed across transmissions that use one or more different frequency regions, and designated use of bands across these frequency regions may differ by country or regulating body.

The wireless communications system 100 may utilize both licensed and unlicensed RF spectrum bands. For example, the wireless communications system 100 may employ License Assisted Access (LAA), LTE-Unlicensed (LTE-U) RAT, or NR technology using an unlicensed band such as the 5 GHz industrial, scientific, and medical (ISM) band. While operating using unlicensed RF spectrum bands, devices such as the network entities 105 and the UEs 115 may employ carrier sensing for collision detection and avoidance. In some examples, operations using unlicensed bands may be based on a carrier aggregation configuration in conjunction with component carriers operating using a licensed band (e.g., LAA). Operations using unlicensed spectrum may include downlink transmissions, uplink transmissions, P2P transmissions, or D2D transmissions, among other examples.

A network entity 105 (e.g., a base station 140, an RU 170) or a UE 115 may be equipped with multiple antennas, which may be used to employ techniques such as transmit diversity, receive diversity, multiple-input multiple-output (MIMO) communications, or beamforming. The antennas of a network entity 105 or a UE 115 may be located within one or more antenna arrays or antenna panels, which may support MIMO operations or transmit or receive beamforming. For example, one or more base station antennas or antenna arrays may be co-located at an antenna assembly, such as an antenna tower. In some examples, antennas or antenna arrays associated with a network entity 105 may be located at diverse geographic locations. A network entity 105 may include an antenna array with a set of rows and columns of antenna ports that the network entity 105 may use to support beamforming of communications with a UE 115. Likewise, a UE 115 may include one or more antenna arrays that may support various MIMO or beamforming operations. Additionally, or alternatively, an antenna panel may support RF beamforming for a signal transmitted via an antenna port.

Beamforming, which may also be referred to as spatial filtering, directional transmission, or directional reception, is a signal processing technique that may be used at a transmitting device or a receiving device (e.g., a network entity 105, a UE 115) to shape or steer an antenna beam (e.g., a transmit beam, a receive beam) along a spatial path between the transmitting device and the receiving device. Beamforming may be achieved by combining the signals communicated via antenna elements of an antenna array such that some signals propagating along particular orientations with respect to an antenna array experience constructive interference while others experience destructive interference. The adjustment of signals communicated via the antenna elements may include a transmitting device or a receiving device applying amplitude offsets, phase offsets, or both to signals carried via the antenna elements associated with the device. The adjustments associated with each of the antenna elements may be defined by a beamforming weight set associated with a particular orientation (e.g., with respect to the antenna array of the transmitting device or receiving device, or with respect to some other orientation).

In some examples of the wireless communications system 100, a wireless device (e.g., a UE 115) may establish a connection with a network entity 105 by performing a RACH procedure. The wireless device may transmit one or more RACH messages for the RACH procedure. The UE 115 may select resources via which to transmit the RACH messages based on receiving paging messages from the network entity 105. In some examples, the wireless device may transmit the one or more RACH messages and monitor for a response (e.g., a random access response (RAR)) from the network entity 105.

Techniques described herein may enable a network entity 105 to use one or more repeaters (e.g., FT-NCRs) to repeat messages to a UE 115. For example, the network entity 105 may configure a set of repeaters to repeat a set of paging messages (e.g., via beams that are QCLed with SSBs associated with SSB IDs) to the UE 115 via a corresponding set of indirect links between the UE 115 and the network entity 105 (e.g., a set of links through the set of repeaters). Each FT-NCR may perform a frequency translation on the corresponding paging message and may transmit the paging message to the UE 115 via a different frequency band than a frequency band associated with a direct link between the UE 115 and the network entity 105. The UE 115 may accordingly receive each paging message via the direct link or via the set of indirect links and may select a link via which to perform a RACH procedure.

In some examples (e.g., if an indirect link frequency is relatively closer to a direct link frequency), the FT-NCR may transmit the corresponding paging message via a same time resource as a paging message transmitted via the direct link. Such techniques may allow the UE 115 to receive and decode multiple paging messages simultaneously, which may decrease latency in the wireless communication system. In some examples (e.g., if the FT-NCR is a digital FT-NCR), the FT-NCR may buffer a corresponding paging message and may transmit the corresponding paging message via a different time resource (e.g., a different time resource in a DRX cycle). Accordingly, the UE 115 may monitor a relatively smaller transmission bandwidth at a given time for paging messages, which may decrease power consumption at the UE 115.

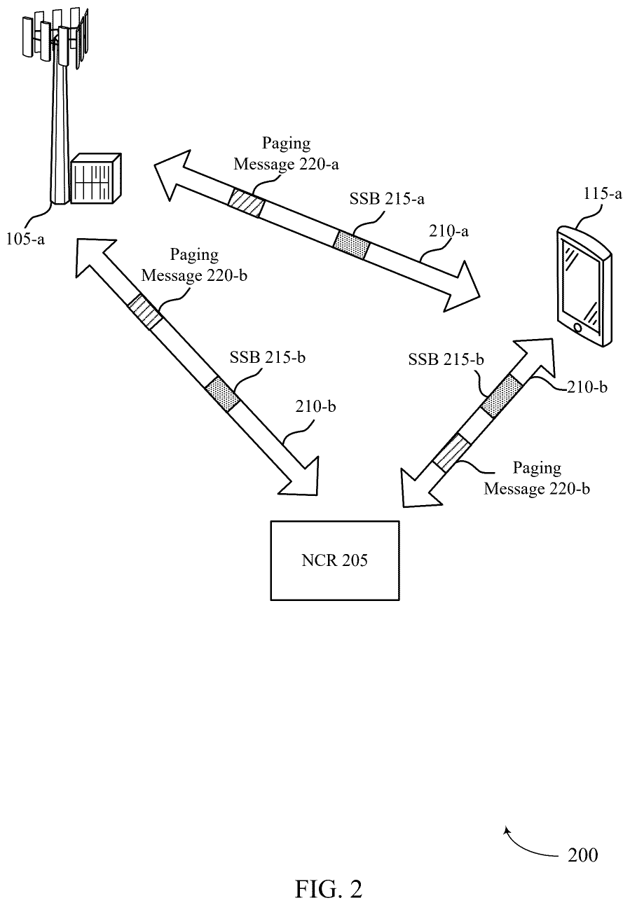

FIG. 2 shows an example of a wireless communications system 200 that supports transmitting paging messages using NCRs in accordance with one or more aspects of the present disclosure. The wireless communications system 200 may implement or may be implemented by aspects of the wireless communications system 100. For example, the wireless communications system 200 may be implemented by a UE 115 (e.g., a UE 115-a) or a network entity 105 (e.g., a network entity 105-a), which may be examples of the corresponding devices as described with reference to FIG. 1.

In some examples of the wireless communications system 200, a network entity 105-a may transmit messages to a UE 115-a via a direct link 210-a (e.g., a link directly between the UE 115-a and the network entity 105-a) or via an indirect link 210-b (e.g., a link between the UE 115-a and a repeater such as an NCR 205 and between the repeater and the network entity 105-a). That is, the network entity 105-a may transmit messages directly to the UE 115-a or may transmit messages to the NCR 205 for repeating to the UE 115-a.

The NCR 205 may be an intelligent repeater that may receive control information from the network entity 105-a (e.g., via a backhaul link between the NCR 205 and the network entity 105-a). The control information may indicate for the NCR 205 to redirect signals and boost signal strength towards UEs 115 (e.g., the UE 115-a) and/or one or more zones in a cell of the network entity 105-a that may receive relatively worse quality of coverage (e.g., lower received signal strength) than one or more other zones.

In some examples, the NCR 205 may be a FT-NCR 205. For example, the NCR 205 may perform a frequency translation to output messages to the UE 115-a via a different frequency band than a frequency band used by the network entity 105-a to output the messages to the FT-NCR 205. The FT-NCR 205 may perform a frequency translation operation to map a backhaul link on a licensed band between the FT-NCR 205 and the network entity 105-a to an access link on a different licensed band (e.g., from a frequency f_{c}¹ to a frequency f_{c}² in a same frequency range). The frequency band used by the FT-NCR 205 to communicate with the UE 115-a may be an access link with a relatively lower load (e.g., less traffic) than one or more other frequency bands. Accordingly, the FT-NCR 205 may communicate with the UE 115-a in a cell edge of the cell of the network entity 105-a with a relatively higher signal-to-interference plus noise ratio (SINR) and lower interference with UEs 115 in neighboring or adjacent cells as compared to boosting a signal power without performing a frequency translation.

The FT-NCR 205 may receive a signal at a first antenna port and transmit the signal at a second antenna port (e.g., and vice-versa). The FT-NCR 205 may perform an amplification (e.g., using an amplifier such as a variable gain amplifier (VGA)) and frequency translation of the signal (e.g., prior to transmitting the signal). To perform frequency translation, the FT-NCR 205 may down convert the signal to a baseband or intermediate frequency (IF) band, and up converting to a target (e.g., desired) frequency. The frequency translation process may be controlled by a repeater mobile termination (MT) that may wirelessly receive control information from another wireless terminal (e.g., the network entity 105-a) and may generate repeater control based on the received control information.

In some examples, the FT-NCR 205 may be a digital repeater. In such examples, the FT-NCR 205 may use additional digital processing to perform a frequency conversion, such as processing a received signal via an RF front-end (RFFE) of the FT-NCR 205 and a baseband modulation and demodulation of a received signal. For example, one or more parameters (e.g., OFDM numerology and slot format) of a first frequency band (e.g., 700 MHz or FR-1) may not be suitable for another frequency band (e.g., 5 GHz or FR-2). The digital FT-NCR 205 may perform operations based on a baseband samples or symbols, such as buffering, frame structure, subcarrier spacing (SCS) translation, and so on.

In some examples, the network entity 105-a may inquire whether the NCR 205 has a buffering capability (e.g., whether the NCR 205 is a digital repeater). For example, the network entity 105-a may transmit a capability request to the NCR 205 (e.g., via the backhaul link between the network entity 105-a and the NCR 205) and the NCR 205 may respond to the capability request with a capability report indicating the capability of the NCR 205 to perform buffering.

In some examples of the wireless communications system 200, the network entity 105-a may use the FT-NCR 205 for paging the UE 115-a. The UE 115-a may be a UE 115 operating in a DRX mode (e.g., in an idle state of the DRX mode). In some examples, the UE 115-a may monitor one paging occasion per DRX cycle (e.g., per cycle of active states and idle states). Accordingly, while in the idle mode, the UE 115-a may either monitor the direct link 210-a (e.g., a primary frequency band f_{c}¹) and use the direct link 210-a for paging occasion or monitor both of the direct link 210-a and the indirect link 210-b (e.g., a secondary frequency band f_{c}²). Monitoring both of the direct link 210-a and the indirect link 210-b may increase a power draw (e.g., power consumption) during the idle state. For example, if a gap between the first frequency band f_{c}¹ and the second frequency band f_{c}² is relatively large, the UE 115-a may monitor a relatively larger bandwidth for paging messages, which may increase power consumption of the UE 115-a. Such increased power consumption may increase further if the wireless communications system 200 includes relatively more FT-NCRs 205 and/or FT-NCRs 205 translating to different frequency channels.

Accordingly, techniques described herein may enable the FT-NCR 205 to repeat paging messages without the UE 115-a incurring relatively high power consumption while in the idle mode such that the UE 115-a may perform RACH using a best available link (e.g., a link associated with a highest received power). Such techniques may reduce the power consumption of the UE 115-a while in the idle state by limiting a bandwidth over which the UE 115-a may decode a paging channel.

The UE 115-a may receive a system information block (SIB) from the network entity 105-a indicating two or more paging occasions (e.g., a paging occasion associated with each link 210, such as the direct link 210-a and one or more indirect links 210-b through one or more corresponding NCRs 205) in a DRX cycle. Each paging occasion may be associated with a corresponding paging message 220. For example, a first paging occasion may be associated with a paging message 220-a (e.g., a paging message 220-a transmitted via the direct link 210-a) and a second paging occasion may be associated with a paging message 220-b (e.g., a paging message 220-b transmitted via the indirect link 210-b). The network entity 105-a may assume that the UE 115-a may decode (e.g., or is capable of decoding) one paging message 220 on one of the configured paging occasions.

In some examples, if the NCR 205 is capable of buffering (e.g., if the NCR 205 is a digital NCR 205), the network entity 105-a may transmit control information to the NCR 205 configuring the NCR 205 to buffer the paging message 220-b. In such examples, the second paging occasion may not overlap in time with the first paging occasion. For example, the NCR 205 may buffer the paging message 220-b until the second paging occasion. Additionally, or alternatively, the network entity 105-a may retransmit the paging message 220-b to the NCR 205 with a time offset (e.g., a time offset between the first paging occasion and the second paging occasion). In some examples, the first paging occasion and the second paging occasion may be aligned in time (e.g., such that the NCR 205 may not buffer the paging message 220-b and/or the network entity 105-a may not retransmit the paging message 220-b).

In some implementations, the network entity 105-a may transmit the paging message 220-a via the direct link 210-a (e.g., via the first frequency band) during the first paging occasion. The network entity 105-a may transmit the paging message 220-b to the NCR 205 for forwarding (e.g., repeating) to the UE 115-a (e.g., via the second frequency band) during the second paging occasion. In some aspects, the network entity 105-a may transmit control information to the NCR 205 indicating for the NCR 205 to perform a frequency translation on the paging message 220-b (e.g., from the first frequency band to the second frequency band). If the NCR 205 is capable of buffering the paging message 220-b, the NCR 205 may transmit the buffered paging message 220-b in multiple beam directions (e.g., via multiple beams).

Each paging occasion may be associated with a group of SSBs 215 (e.g., SSBs 215 transmitted prior to the paging messages 220). For example, the network entity 105-a may transmit the paging message 220-a via a beam that is quasi co-located (QCLed) with an SSB 215-a and the paging message 220-b via a beam that is quasi co-located (QCLed) with an SSB 215-b. As described herein, a group of SSBs 215 may be associated with a set of SSB indices.

The network entity 105-a may assume that the UE 115-a may decode one paging message 220 on one of the multiple configured paging occasions. In such examples, the network entity 105-a may not be aware which paging occasion (e.g., if any) that a UE 115-a is monitoring (e.g., listening). For example, the network entity 105-a may not know if the UE 115-a decodes the paging message 220-a over the direct link 210-a during the first paging occasion or the paging message 220-b over the indirect link 210-b during the second paging occasion.

The UE 115-a (e.g., a UE 115 with a relatively lower power budget than some other UEs 115) may choose a link over which to monitor the associated paging occasion (e.g., by selecting one of the direct link 210-a or the indirect link 210-b). For example, the UE 115-a may perform one or more measurements of the direct link 210-a and the indirect link 210-b (e.g., by measuring a received power and/or a signal-to-noise ratio (SNR) of the SSBs 215 transmitted via each link 210). The UE 115-a may determine to decode the paging message 220-a if the direct link 210-a is associated with a higher quality (e.g., a higher measured power), and may determine to decode the paging message 220-b if the indirect link 210-b is associated with a higher quality (e.g., a higher measured power).

The UE 115-a may reselect a link 210 (e.g., select a different link 210 over which to decode paging occasions) based on one or more additional power measurements. For example, if the UE 115-a initially determines that the direct link 210-a has a higher quality (e.g., a higher received power) than the indirect link 210-b, the UE 115-a may initially select the direct link 210-a. In examples in which UE 115-a performs one or more subsequent measurements (e.g., power measurements of one or more subsequent messages, such as additional SSBs 215), the UE 115-a may determine that the indirect link 210-b has a higher quality (e.g., a higher received power, a power that is a threshold quantity of decibels higher) than the direct link 210-a. The UE 115-a may accordingly reselect the link 210 over which the UE 115-a may monitor (e.g., listen) for paging messages 220.

In some examples, the UE 115-a (e.g., a UE 115 with a relatively larger power budget than one or more other UEs 115) may monitor all possible paging occasions (e.g., all paging occasions indicated via the SIB, associated with the direct link 210-a and all NCR or indirect links 210-b associated with all NCRs 205). Such techniques may result in relatively higher power consumption at the UE 115-a as compared to examples in which the UE 115-a may decode a single paging occasion.

The UE 115-a may transmit a message of a RACH procedure (e.g., a msg1 of a four-step RACH procedure, a msgA of a two-step RACH procedure) via a link 210 that the UE 115-a received a paging message 220 (e.g., in response to receiving the paging message 220). For example, if the UE 115-a selects the direct link 210-a to monitor paging occasions, the UE 115-a may receive the paging message 220-a and may transmit the RACH message via the direct link 210-a to the network entity 105-a. If the UE 115-a selects the indirect link 210-b to monitor paging occasions, the UE 115-a may receive the paging message 220-b and may transmit the RACH message via the indirect link 210-b to the NCR 205 for forwarding to the network entity 105-a. In examples, in which the UE 115-a monitors multiple (e.g., all) paging occasions, the UE 115-a may select a link 210 over which to transmit the RACH message, or may transmit the RACH message over all links 210 that the UE 115-a received a paging message 220 over.

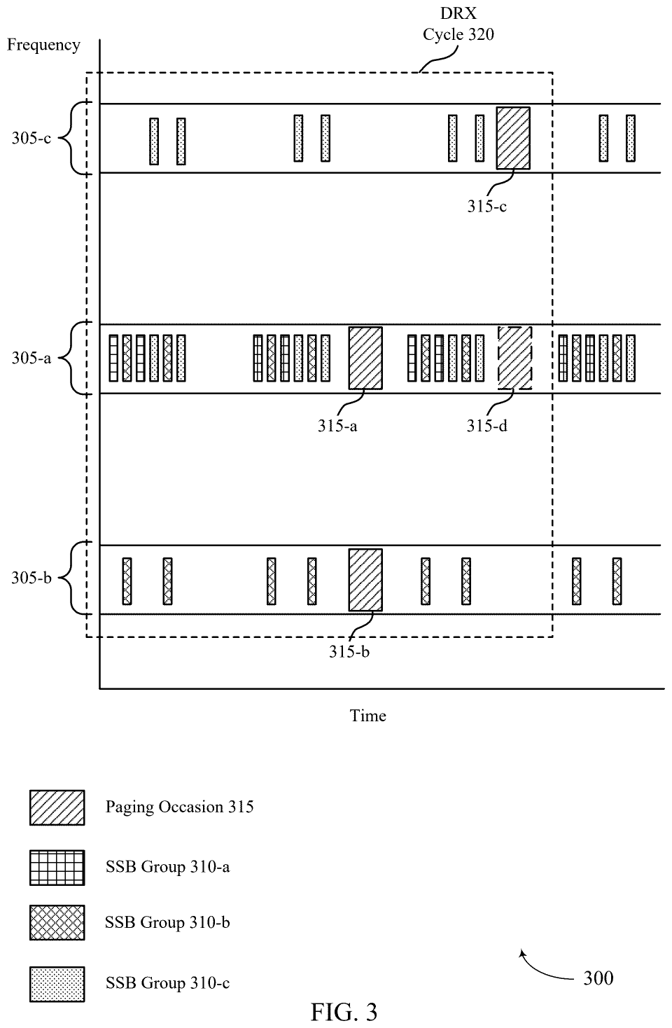

FIG. 3 shows an example of a timing diagram 300 that supports transmitting paging messages using NCRs in accordance with one or more aspects of the present disclosure. The timing diagram 300 may implement or may be implemented by aspects of the wireless communications system 100 or the wireless communications system 200. For example, the timing diagram 300 may be implemented by a UE 115, a network entity 105, and a NCR, which may be examples of the corresponding devices as described with reference to FIGS. 1 and 2.

In some examples, as described with reference to FIG. 2, a UE 115 may receive paging messages over one or more links, including a direct link with a network entity 105 and one or more indirect links with the network entity 105 through one or more corresponding repeaters (e.g., NCRs, FT-NCRs). Each paging message may be transmitted via a respective link associated with a respective frequency band 305 and during a respective paging occasion 315.

In some examples, each paging occasion 315 may be associated with an SSB group 310. For example, a beam used to transmit a paging message during a paging occasion 315 may be QCLed with a beam used to transmit one or more SSBs of an associated SSB group 310. Accordingly, each respective repeater may repeat SSBs of the SSB group 310 that is associated with the paging occasion of the respective frequency band 305 used by the respective repeater.

As an illustrative example, the network entity may transmit six SSBs with SSB indices of 0, 1, 2, 3, 4, and 5. As illustrated with reference to FIG. 3, SSBs with SSB indices 0 and 2 may be in an SSB group 310-a associated with the direct link (e.g., with a paging occasion 315-a on the frequency band 305-a). SSBs with SSB indices 1 and 4 may be in an SSB group 310-b associated with a first indirect link of a first repeater (e.g., with a paging occasion 315-b on the frequency band 305-b). SSBs with SSB indices 3 and 5 may be in an SSB group 310-c associated with a second indirect link of a second repeater (e.g., with a paging occasion 315-c on the frequency band 305-c). SSB grouping may be performed based on a capability of the repeaters to perform frequency translation on the transmitted SSBs.

The network entity 105 may transmit each SSB via the frequency band 305-a. For example, the network entity 105 may transmit the SSBs of the SSB group 310-a to the UE 115, the SSBs of the SSB group 310-b to the first repeater, and SSBs of the SSB group 310-c to the second repeater. The first repeater may perform a frequency translation on the SSBs of the SSB group 310-b and may transmit the SSBs of the SSB group 310-b to the UE 115 via the frequency band 305-b. The second repeater may perform a frequency translation on the SSBs of the SSB group 310-c and may transmit the SSBs of the SSB group 310-c to the UE 115 via the frequency band 305-c. The network entity 105 (e.g., and the repeaters) may transmit SSBs periodically with a first periodicity (e.g., 20 ms when the UE 115 is in an active state of a DRX mode) and with a second periodicity that may be longer than the first periodicity (e.g., with the UE 115 is in an inactive or idle state of the DRX mode). The UE 115 may decode the SSBs at the corresponding periodicity.

The network entity 105 may transmit a paging message during the paging occasion 315-a via the frequency band 305-a to the UE 115 (e.g., via the direct link via a beam QCLed with the SSB group 310-a) and to each respective repeater (e.g., via the respective indirect links). The first repeater may perform a frequency translation of the first paging message and may repeat the paging message to the UE 115 during the paging occasion 315-b (e.g., via the first indirect link via a beam QCLed with the SSB group 310-b). The second repeater may perform a frequency translation of the first paging message and may repeat the paging message to the UE 115 during the paging occasion 315-c (e.g., via the second indirect link via a beam QCLed with the SSB group 310-c).

In some aspects, a paging occasion 315 on an indirect link may overlap in time (e.g., may be time aligned) with the paging occasion 315-a on the direct link. For example, the paging occasion 315-b may have time resources that overlap with time resources of the paging occasion 315-a. Additionally, or alternatively, a paging occasion 315 may not overlap in time (e.g., may not be time aligned) with the paging occasion 315-a on the direct link. For example, if the second repeater is capable of performing buffering (e.g., if the second repeater is a digital repeater), the second repeater may buffer the paging message until time resources associated with the paging occasion 315-c.

If the second repeater is not capable of performing buffering, the network entity 105 may transmit a second paging message during a paging occasion 315-d that overlaps in time with the paging occasion 315-c such that the second repeater may repeat the paging message during the paging occasion 315-c. In such examples (e.g., for beam-based access), the network entity 105 may repeat the first paging message over all beams that are QCLed with SSB groups 310 for which the associated paging occasions 315 are aligned with the earliest paging occasion 315-a on any channel (e.g., the direct link, the indirect links). The network entity 105 may repeat the second paging message over all beams that are QCLed with SSB groups 310 for which the associated paging occasions 315 are aligned with the next earliest paging occasion 315-c on any channel (e.g., the direct link, the indirect links), and so on for any following paging occasions 315. For example, as illustrated with reference to FIG. 3, the network entity 105 may transmit the paging message on beams QCLed with the SSB group 310-a and the SSB group 310-b (e.g., SSB indices 0, 1, 2, and 4) during the paging occasion 315-a, and on beams QCLed with the SSB group 310-c (e.g., SSB indices 3 and 5) during the paging occasion 315-c.

In some examples, if the network entity 105 determines that one or more paging occasions 315 may not be time aligned (e.g., if time alignment is not possible or desirable), the network entity 105 may configure each repeater with a different timing or paging offset. For example, the network entity 105 may transmit a paging offset indication indicating a time offset between the paging occasion 315-a and each respective paging message.

The network entity 105 may determine whether each paging occasion 315 may be time aligned based on each frequency band 305. For example, if the frequency band 305-b is within a threshold frequency of the frequency band 305-a, the network entity 105 may configure the paging occasion 315-b to align in time with the paging occasion 315-a. Accordingly, the UE 115 may monitor both of the paging occasion 315-a and the paging occasion 315-b at a given time during a DRX cycle 320, which may enable the UE 115 to remain awake for a relatively shorter period of time. Additionally, or alternatively, if the frequency band 305-c is not within the threshold frequency of the frequency band 305-a, the network entity 105 may configure the paging occasion 315-c to not align in time with the paging occasion 315-a (e.g., with a time offset). Accordingly, the UE 115 may monitor a relatively smaller bandwidth (e.g., one of the frequency band 305-a or the frequency band 305-b) during the DRX cycle 320, which may reduce a power consumption associated with monitoring both frequency bands 305.

In some examples, the UE 115 may monitor a single paging occasion 315 during a DRX cycle 320 (e.g., regardless of the associated time offsets). In such examples, the network entity 105 may assume that the UE 115 may decode one of multiple configured paging occasions 315 (e.g., based on measurements of the associated SSBs).

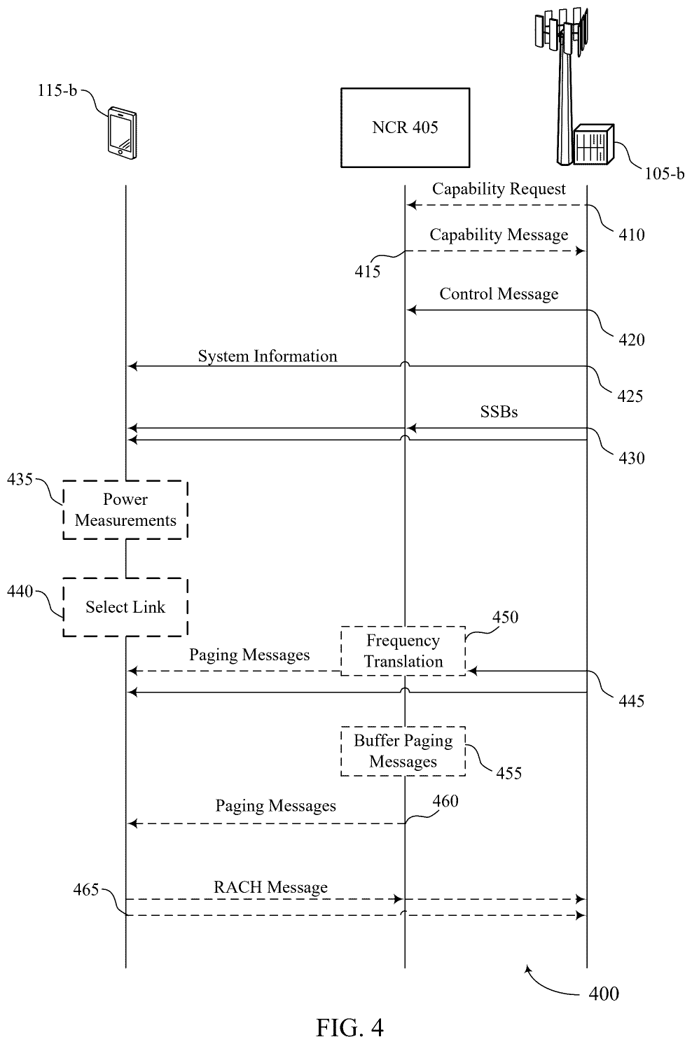

FIG. 4 shows an example of a process flow 400 that supports transmitting paging messages using NCRs in accordance with one or more aspects of the present disclosure. The process flow 400 may implement or may be implemented by aspects of the wireless communications system 100 or the wireless communications system 200. For example, the process flow 400 may be implemented by a UE 115 (e.g., a UE 115-b), a network entity 105 (e.g., a network entity 105-a), and a NCR 405, which may be examples of the corresponding devices as described with reference to FIGS. 1 and 2.

In the following description of the process flow 400, the operations between the UE 115-b, the network entity 105-b, and the NCR 405 may occur in a different order than the example order shown and, in some examples, may be performed by one or more different devices other than those shown as examples. Some operations also may be omitted from the process flow 400, and other operations may be added to the process flow 400. Further, although some operations or signaling may be shown to occur at different times for discussion purposes, these operations may actually occur at the same time.

In some examples, at 410, the network entity 105-b may output a capability request to the NCR 405. The capability request may include a request for buffering capability information of the NCR 405. At 415, the NCR 405 may output a capability message including the capability information (e.g., the capability of the NCR 405 to perform buffering) in response to the capability request.

At 420, the network entity 105-b may output a control message to the NCR 405 indicating a paging configuration. The paging configuration may indicate one or more SSBs of a set of SSBs and one or more paging messages of a set of paging messages for the NCR 405 to repeat to the UE 115-b. In some examples, each of the one or more paging messages may be associated with an SSB ID of one of the one or more SSBs. For example, one or more beams allocated for the paging messages may be QCLed with one or more beams allocated for the SSBs. In some examples, the control message (e.g., or another control message from the network entity 105-b to the NCR 405) may indicate for the NCR 405 to perform buffering (e.g., in accordance with the capability of the NCR 405 to perform buffering).

At 425, the network entity 105-b may output system information to the UE 115-b. The system information may indicate a plurality of paging occasions (e.g., resources via which the UE 115-b may receive paging messages). A first paging occasion of the plurality of paging occasions may be a paging occasion for a first paging message of the set of paging messages to be received via a direct link between the UE 115-b and the network entity 105-b. A second paging occasion of the plurality of paging occasions may be a paging occasion for a second paging message of the set of paging messages to be received via an indirect link between the UE 115-b and the network entity 105-b (e.g., a link between the UE 115-b and the NCR 405).

At 430, the network entity 105-b may output the set of SSBs (e.g., via one or more sets of beams). For example, the network entity 105-b may output the set of SSBs to the UE 115-b (e.g., via the direct link) and the NCR 405. The NCR 405 may forward (e.g., repeat) one or more of the set of SSBs to the UE 115-b (e.g., via the indirect link).

In some examples, at 435, the UE 115-b may perform one or more power measurements of the SSBs. In some examples, the UE 115-b may receive one or more additional SSBs from the network entity 105-b and/or the NCR 405 and may perform one or more additional power measurements of the one or more additional SSBs. At 440, the UE 115-b may select a link (e.g., the direct link or the indirect link) based on the power measurements. For example, the UE 115-b may select a link associated with a highest measured power.

At 445, the network entity 105-b may output the set of paging messages (e.g., via a first frequency band). For example, the network entity 105-b may output the first paging message to the UE 115-b during the first paging occasion via the direct link. The network entity 105-b may output the second paging message to the NCR 405 via the indirect link. The network entity 105-b may output the first paging message and the second paging message via beams that are QCLed with one or more of the one or more sets of beams used to transmit the SSBs. For example, a first beam used to transmit the first paging message may be QCLed with a first set of SSBs and a second beam used to transmit the second paging message may be QCLed with a second set of SSBs.

At 450, the NCR 405 may perform a frequency translation on the second paging message (e.g., in accordance with the configuration). The NCR 405 may output the second paging message to the UE 115-b via the indirect link (e.g., via time resources that overlap with the first paging occasion). In some examples (e.g., if the NCR 405 is capable of performing buffering), the second paging occasion may not overlap in time with the first paging occasion. In such examples, at 455, the NCR 405 may buffer the second paging message. At 460, the NCR 405 may output the second paging message to the UE 115-b during the second paging occasion via the indirect link (e.g., via time resources that do not overlap with the first paging occasion). The NCR 405 may output the second paging message via a second frequency band in accordance with performing the frequency translation.

The UE 115-b may receive one or more of the set of paging messages. In some examples, the UE 115-b may decode paging messages received via the selected one of the direct link or the indirect link (e.g., based on the power measurements). Additionally, or alternatively, the UE 115-b may receive the first paging message (e.g., from the network entity 105-b) during the first paging occasion via the direct link and the second paging message (e.g., from the NCR 405) during the second paging occasion via the indirect link (e.g., via time resources that overlap or do not overlap with the first paging occasion). In some examples, the UE 115-b may receive the paging messages while the UE 115-b is in an idle state of a DRX mode.

At 465, the UE 115-b may output a RACH message of a RACH procedure. The UE 115-b may output the RACH message via one of the direct link (e.g., to the network entity 105-b) or the indirect link (e.g., to the NCR 405 for forwarding to the network entity 105-b) based on receiving the one or more paging messages. For example, the UE 115-b may output the RACH message via the selected link (e.g., the link associated with the higher measured power) based on receiving the first paging message or the second paging message via the selected link.

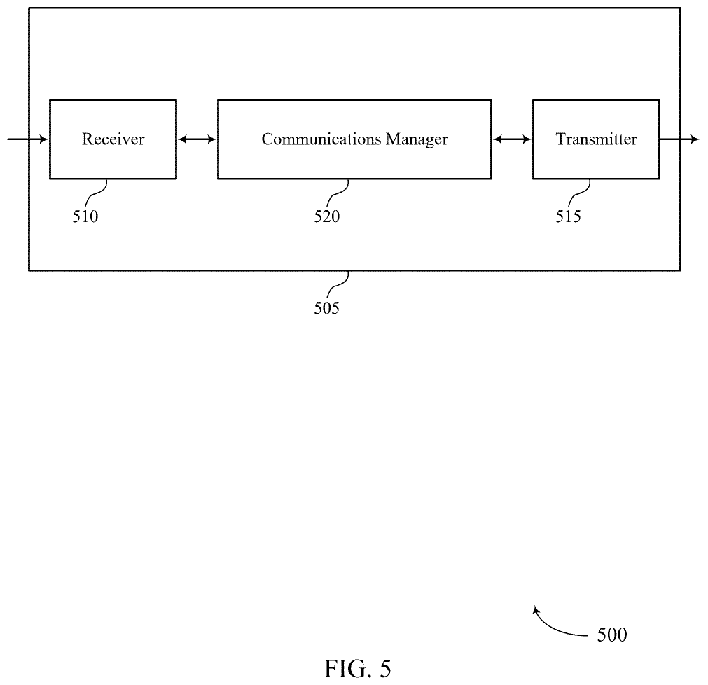

FIG. 5 shows a block diagram 500 of a device 505 that supports transmitting paging messages using NCRs in accordance with one or more aspects of the present disclosure. The device 505 may be an example of aspects of a network entity 105 as described herein. The device 505 may include a receiver 510, a transmitter 515, and a communications manager 520. The device 505, or one or more components of the device 505 (e.g., the receiver 510, the transmitter 515, the communications manager 520), may include at least one processor, which may be coupled with at least one memory, to, individually or collectively, support or enable the described techniques. Each of these components may be in communication with one another (e.g., via one or more buses).

The receiver 510 may provide a means for obtaining (e.g., receiving, determining, identifying) information such as user data, control information, or any combination thereof (e.g., I/Q samples, symbols, packets, protocol data units, service data units) associated with various channels (e.g., control channels, data channels, information channels, channels associated with a protocol stack). Information may be passed on to other components of the device 505. In some examples, the receiver 510 may support obtaining information by receiving signals via one or more antennas. Additionally, or alternatively, the receiver 510 may support obtaining information by receiving signals via one or more wired (e.g., electrical, fiber optic) interfaces, wireless interfaces, or any combination thereof.

The transmitter 515 may provide a means for outputting (e.g., transmitting, providing, conveying, sending) information generated by other components of the device 505. For example, the transmitter 515 may output information such as user data, control information, or any combination thereof (e.g., I/Q samples, symbols, packets, protocol data units, service data units) associated with various channels (e.g., control channels, data channels, information channels, channels associated with a protocol stack). In some examples, the transmitter 515 may support outputting information by transmitting signals via one or more antennas. Additionally, or alternatively, the transmitter 515 may support outputting information by transmitting signals via one or more wired (e.g., electrical, fiber optic) interfaces, wireless interfaces, or any combination thereof. In some examples, the transmitter 515 and the receiver 510 may be co-located in a transceiver, which may include or be coupled with a modem.

The communications manager 520, the receiver 510, the transmitter 515, or various combinations or components thereof may be examples of means for performing various aspects of paging messages using NCRs as described herein. For example, the communications manager 520, the receiver 510, the transmitter 515, or various combinations or components thereof may be capable of performing one or more of the functions described herein.

In some examples, the communications manager 520, the receiver 510, the transmitter 515, or various combinations or components thereof may be implemented in hardware (e.g., in communications management circuitry). The hardware may include at least one of a processor, a DSP, a CPU, an ASIC, an FPGA or other programmable logic device, a microcontroller, discrete gate or transistor logic, discrete hardware components, or any combination thereof configured as or otherwise supporting, individually or collectively, a means for performing the functions described in the present disclosure. In some examples, at least one processor and at least one memory coupled with the at least one processor may be configured to perform one or more of the functions described herein (e.g., by one or more processors, individually or collectively, executing instructions stored in the at least one memory).

Additionally, or alternatively, the communications manager 520, the receiver 510, the transmitter 515, or various combinations or components thereof may be implemented in code (e.g., as communications management software or firmware) executed by at least one processor (e.g., referred to as a processor-executable code). If implemented in code executed by at least one processor, the functions of the communications manager 520, the receiver 510, the transmitter 515, or various combinations or components thereof may be performed by a general-purpose processor, a DSP, a CPU, an ASIC, an FPGA, a microcontroller, or any combination of these or other programmable logic devices (e.g., configured as or otherwise supporting, individually or collectively, a means for performing the functions described in the present disclosure).

In some examples, the communications manager 520 may be configured to perform various operations (e.g., receiving, obtaining, monitoring, outputting, transmitting) using or otherwise in cooperation with the receiver 510, the transmitter 515, or both. For example, the communications manager 520 may receive information from the receiver 510, send information to the transmitter 515, or be integrated in combination with the receiver 510, the transmitter 515, or both to obtain information, output information, or perform various other operations as described herein.

The communications manager 520 may support wireless communications in accordance with examples as disclosed herein. For example, the communications manager 520 is capable of, configured to, or operable to support a means for outputting system information indicating a set of multiple paging occasions, where a first paging occasion of the set of multiple paging occasions is associated with a direct link between the network entity and a UE, and where a second paging occasion of the set of multiple paging occasions is associated with a link between the UE and a repeater. The communications manager 520 is capable of, configured to, or operable to support a means for outputting a set of multiple paging messages, each of the set of multiple paging messages associated with a corresponding one of the set of multiple paging occasions. The communications manager 520 is capable of, configured to, or operable to support a means for obtaining a message associated with a RACH procedure based on outputting the set of multiple paging messages.

Additionally, or alternatively, the communications manager 520 may support wireless communications in accordance with examples as disclosed herein. For example, the communications manager 520 is capable of, configured to, or operable to support a means for obtaining a control message indicating a paging configuration, the paging configuration including an indication of one or more SSBs and one or more paging messages associated with the one or more SSBs for the repeater to repeat. The communications manager 520 is capable of, configured to, or operable to support a means for obtaining the one or more SSBs and the one or more paging messages. The communications manager 520 is capable of, configured to, or operable to support a means for outputting the one or more SSBs and the one or more paging messages in accordance with the configuration.

By including or configuring the communications manager 520 in accordance with examples as described herein, the device 505 (e.g., at least one processor controlling or otherwise coupled with the receiver 510, the transmitter 515, the communications manager 520, or a combination thereof) may support techniques for repeating paging messages using NCRs, which may result in reduced power consumption and more efficient utilization of communication resources.

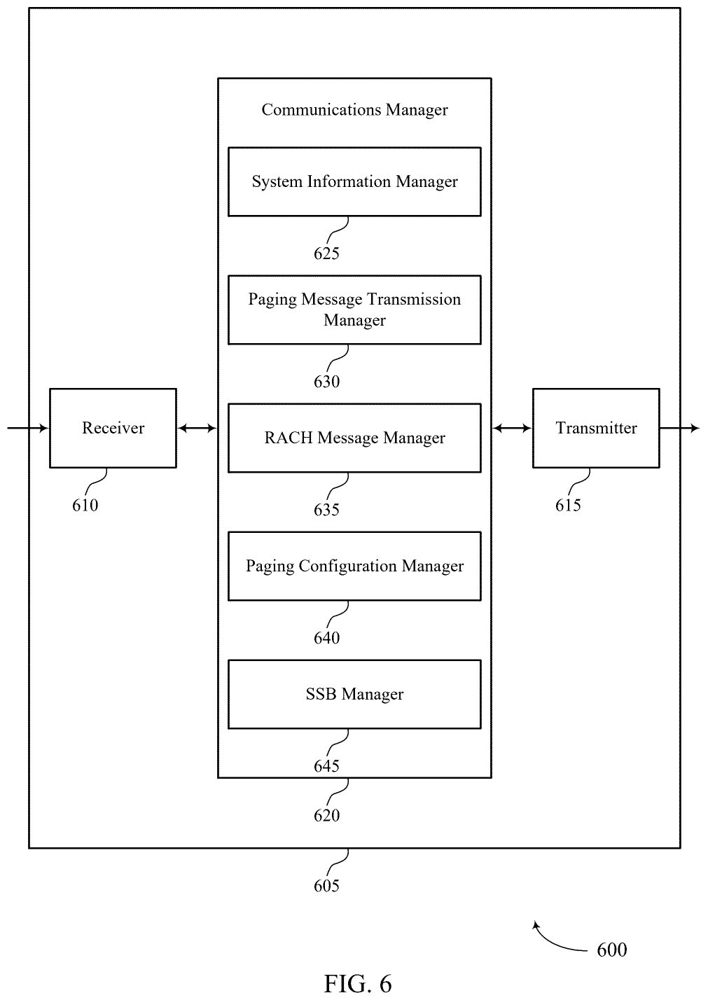

FIG. 6 shows a block diagram 600 of a device 605 that supports transmitting paging messages using NCRs in accordance with one or more aspects of the present disclosure. The device 605 may be an example of aspects of a device 505 or a network entity 105 as described herein. The device 605 may include a receiver 610, a transmitter 615, and a communications manager 620. The device 605, or one or more components of the device 605 (e.g., the receiver 610, the transmitter 615, the communications manager 620), may include at least one processor, which may be coupled with at least one memory, to support the described techniques. Each of these components may be in communication with one another (e.g., via one or more buses).

The receiver 610 may provide a means for obtaining (e.g., receiving, determining, identifying) information such as user data, control information, or any combination thereof (e.g., I/Q samples, symbols, packets, protocol data units, service data units) associated with various channels (e.g., control channels, data channels, information channels, channels associated with a protocol stack). Information may be passed on to other components of the device 605. In some examples, the receiver 610 may support obtaining information by receiving signals via one or more antennas. Additionally, or alternatively, the receiver 610 may support obtaining information by receiving signals via one or more wired (e.g., electrical, fiber optic) interfaces, wireless interfaces, or any combination thereof.

The transmitter 615 may provide a means for outputting (e.g., transmitting, providing, conveying, sending) information generated by other components of the device 605. For example, the transmitter 615 may output information such as user data, control information, or any combination thereof (e.g., I/Q samples, symbols, packets, protocol data units, service data units) associated with various channels (e.g., control channels, data channels, information channels, channels associated with a protocol stack). In some examples, the transmitter 615 may support outputting information by transmitting signals via one or more antennas. Additionally, or alternatively, the transmitter 615 may support outputting information by transmitting signals via one or more wired (e.g., electrical, fiber optic) interfaces, wireless interfaces, or any combination thereof. In some examples, the transmitter 615 and the receiver 610 may be co-located in a transceiver, which may include or be coupled with a modem.

The device 605, or various components thereof, may be an example of means for performing various aspects of paging messages using NCRs as described herein. For example, the communications manager 620 may include a system information manager 625, a paging message transmission manager 630, a RACH message manager 635, a paging configuration manager 640, an SSB manager 645, or any combination thereof. The communications manager 620 may be an example of aspects of a communications manager 520 as described herein. In some examples, the communications manager 620, or various components thereof, may be configured to perform various operations (e.g., receiving, obtaining, monitoring, outputting, transmitting) using or otherwise in cooperation with the receiver 610, the transmitter 615, or both. For example, the communications manager 620 may receive information from the receiver 610, send information to the transmitter 615, or be integrated in combination with the receiver 610, the transmitter 615, or both to obtain information, output information, or perform various other operations as described herein.

The communications manager 620 may support wireless communications in accordance with examples as disclosed herein. The system information manager 625 is capable of, configured to, or operable to support a means for outputting system information indicating a set of multiple paging occasions, where a first paging occasion of the set of multiple paging occasions is associated with a direct link between the network entity and a UE, and where a second paging occasion of the set of multiple paging occasions is associated with a link between the UE and a repeater. The paging message transmission manager 630 is capable of, configured to, or operable to support a means for outputting a set of multiple paging messages, each of the set of multiple paging messages associated with a corresponding one of the set of multiple paging occasions. The RACH message manager 635 is capable of, configured to, or operable to support a means for obtaining a message associated with a RACH procedure based on outputting the set of multiple paging messages.

Additionally, or alternatively, the communications manager 620 may support wireless communications in accordance with examples as disclosed herein. The paging configuration manager 640 is capable of, configured to, or operable to support a means for obtaining a control message indicating a paging configuration, the paging configuration including an indication of one or more SSBs and one or more paging messages associated with the one or more SSBs for the repeater to repeat. The SSB manager 645 is capable of, configured to, or operable to support a means for obtaining the one or more SSBs and the one or more paging messages. The SSB manager 645 is capable of, configured to, or operable to support a means for outputting the one or more SSBs and the one or more paging messages in accordance with the configuration.

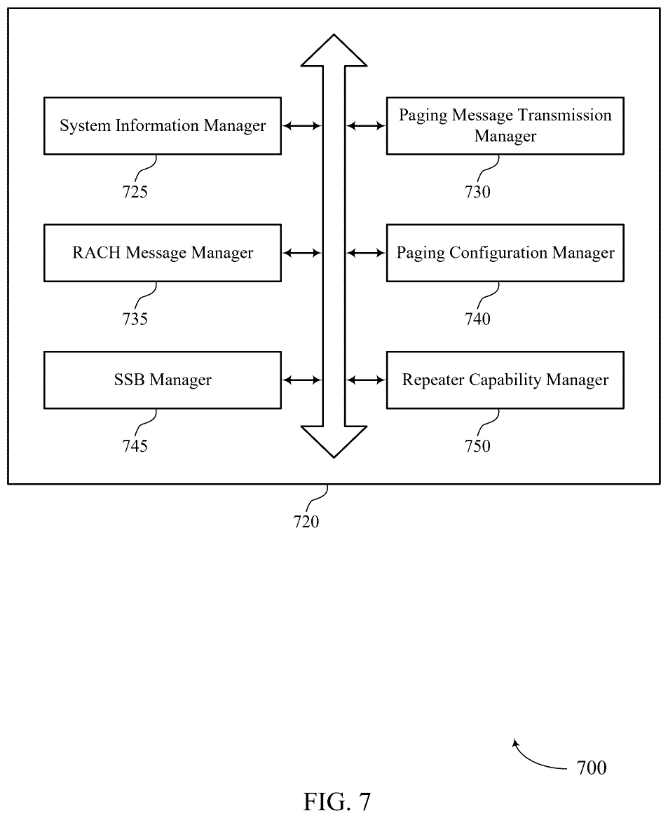

FIG. 7 shows a block diagram 700 of a communications manager 720 that supports transmitting paging messages using NCRs in accordance with one or more aspects of the present disclosure. The communications manager 720 may be an example of aspects of a communications manager 520, a communications manager 620, or both, as described herein. The communications manager 720, or various components thereof, may be an example of means for performing various aspects of paging messages using NCRs as described herein. For example, the communications manager 720 may include a system information manager 725, a paging message transmission manager 730, a RACH message manager 735, a paging configuration manager 740, an SSB manager 745, a repeater capability manager 750, or any combination thereof. Each of these components, or components or subcomponents thereof (e.g., one or more processors, one or more memories), may communicate, directly or indirectly, with one another (e.g., via one or more buses). The communications may include communications within a protocol layer of a protocol stack, communications associated with a logical channel of a protocol stack (e.g., between protocol layers of a protocol stack, within a device, component, or virtualized component associated with a network entity 105, between devices, components, or virtualized components associated with a network entity 105), or any combination thereof.

The communications manager 720 may support wireless communications in accordance with examples as disclosed herein. The system information manager 725 is capable of, configured to, or operable to support a means for outputting system information indicating a set of multiple paging occasions, where a first paging occasion of the set of multiple paging occasions is associated with a direct link between the network entity and a UE, and where a second paging occasion of the set of multiple paging occasions is associated with a link between the UE and a repeater. The paging message transmission manager 730 is capable of, configured to, or operable to support a means for outputting a set of multiple paging messages, each of the set of multiple paging messages associated with a corresponding one of the set of multiple paging occasions. The RACH message manager 735 is capable of, configured to, or operable to support a means for obtaining a message associated with a RACH procedure based on outputting the set of multiple paging messages.

In some examples, to support outputting the set of multiple paging messages, the paging message transmission manager 730 is capable of, configured to, or operable to support a means for outputting a first paging message to the UE during the first paging occasion via the direct link between the network entity and the user equipment. In some examples, to support outputting the set of multiple paging messages, the paging message transmission manager 730 is capable of, configured to, or operable to support a means for outputting a second paging message to the repeater.

In some examples, the paging configuration manager 740 is capable of, configured to, or operable to support a means for outputting a control message indicating a paging configuration, the paging configuration including an indication of one or more SSBs and one or more paging messages of the set of multiple paging messages for the repeater to repeat, where the one or more paging messages are associated with the one or more SSBs.

In some examples, to support outputting the set of multiple paging messages, the repeater capability manager 750 is capable of, configured to, or operable to support a means for outputting a capability request message including a request for buffering capability information associated with the repeater. In some examples, to support outputting the set of multiple paging messages, the repeater capability manager 750 is capable of, configured to, or operable to support a means for obtaining a capability message indicating a capability of the repeater to perform buffering in response to the capability request message.

In some examples, the repeater capability manager 750 is capable of, configured to, or operable to support a means for outputting a control message configuring the repeater to buffer a paging message of the set of multiple paging messages based on the capability of the repeater to perform buffering, where first time resources associated with the first paging occasion do not overlap with second time resources associated with the second paging occasion.

In some examples, to support outputting the set of multiple paging messages, the paging message transmission manager 730 is capable of, configured to, or operable to support a means for outputting a first paging message to the UE during the first paging occasion via the direct link between the network entity and the user equipment. In some examples, to support outputting the set of multiple paging messages, the paging message transmission manager 730 is capable of, configured to, or operable to support a means for outputting a second paging message during the second paging occasion based on an inability of the repeater to perform buffering, where first time resources associated with the first paging occasion do not overlap with second time resources associated with the second paging occasion.

In some examples, to support outputting the set of multiple paging messages, the paging message transmission manager 730 is capable of, configured to, or operable to support a means for outputting the first paging message via a first set of beams that are QCLed with a first subset of SSBs. In some examples, to support outputting the set of multiple paging messages, the paging message transmission manager 730 is capable of, configured to, or operable to support a means for outputting the second paging message via a second set of beams that are QCLed with a second subset of SSBs based on the inability of the repeater to perform buffering.

In some examples, the first paging occasion overlaps in time with the second paging occasion.

Additionally, or alternatively, the communications manager 720 may support wireless communications in accordance with examples as disclosed herein. The paging configuration manager 740 is capable of, configured to, or operable to support a means for obtaining a control message indicating a paging configuration, the paging configuration including an indication of one or more SSBs and one or more paging messages associated with the one or more SSBs for the repeater to repeat. The SSB manager 745 is capable of, configured to, or operable to support a means for obtaining the one or more SSBs and the one or more paging messages. In some examples, the SSB manager 745 is capable of, configured to, or operable to support a means for outputting the one or more SSBs and the one or more paging messages in accordance with the configuration.

In some examples, the paging configuration manager 740 is capable of, configured to, or operable to support a means for performing a frequency translation on the one or more SSBs and the one or more paging messages in accordance with the configuration. In some examples, the paging message transmission manager 730 is capable of, configured to, or operable to support a means for outputting the one or more SSBs and the one or more paging messages via a second frequency band, where obtaining the one or more SSBs and the one or more paging messages includes obtaining the one or more SSBs and the one or more paging messages via a first frequency band that is different from the second frequency band in accordance with the frequency translation.

In some examples, the repeater capability manager 750 is capable of, configured to, or operable to support a means for obtaining a capability request message including a request for buffering capability information associated with the repeater. In some examples, the repeater capability manager 750 is capable of, configured to, or operable to support a means for outputting a capability message indicating a capability of the repeater to perform buffering in response to the capability request message.

In some examples, the control message indicates for the repeater to buffer the one or more paging messages based on the capability of the repeater to perform buffering.

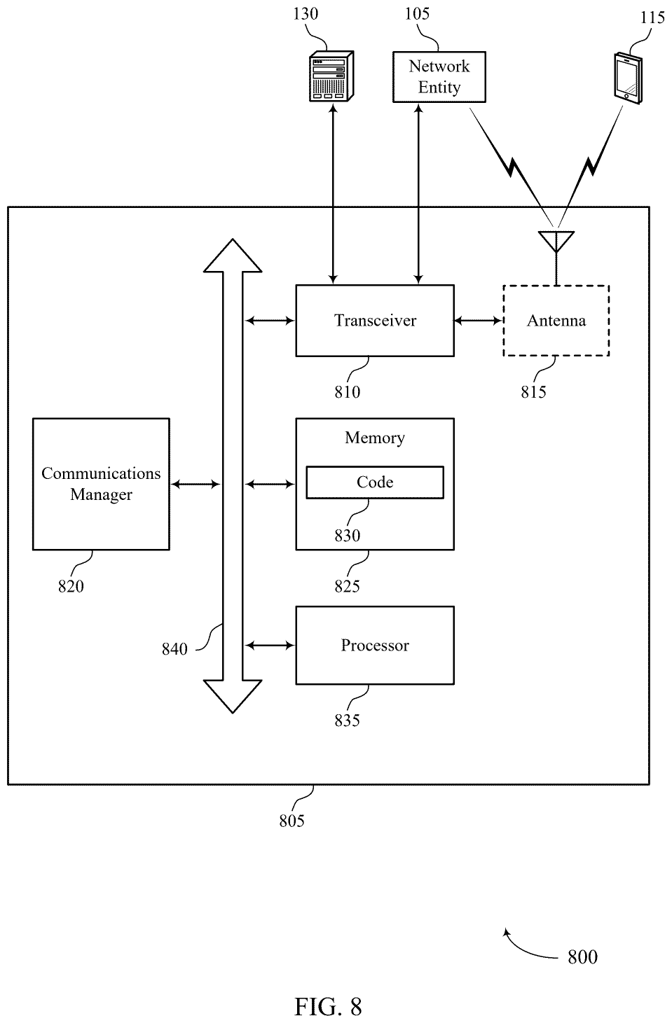

FIG. 8 shows a diagram of a system 800 including a device 805 that supports transmitting paging messages using NCRs in accordance with one or more aspects of the present disclosure. The device 805 may be an example of or include components of a device 505, a device 605, or a network entity 105 as described herein. The device 805 may communicate with other network devices or network equipment such as one or more of the network entities 105, UEs 115, or any combination thereof. The communications may include communications over one or more wired interfaces, over one or more wireless interfaces, or any combination thereof. The device 805 may include components that support outputting and obtaining communications, such as a communications manager 820, a transceiver 810, one or more antennas 815, at least one memory 825, code 830, and at least one processor 835. These components may be in electronic communication or otherwise coupled (e.g., operatively, communicatively, functionally, electronically, electrically) via one or more buses (e.g., a bus 840).

The transceiver 810 may support bi-directional communications via wired links, wireless links, or both as described herein. In some examples, the transceiver 810 may include a wired transceiver and may communicate bi-directionally with another wired transceiver. Additionally, or alternatively, in some examples, the transceiver 810 may include a wireless transceiver and may communicate bi-directionally with another wireless transceiver. In some examples, the device 805 may include one or more antennas 815, which may be capable of transmitting or receiving wireless transmissions (e.g., concurrently). The transceiver 810 may also include a modem to modulate signals, to provide the modulated signals for transmission (e.g., by one or more antennas 815, by a wired transmitter), to receive modulated signals (e.g., from one or more antennas 815, from a wired receiver), and to demodulate signals. In some implementations, the transceiver 810 may include one or more interfaces, such as one or more interfaces coupled with the one or more antennas 815 that are configured to support various receiving or obtaining operations, or one or more interfaces coupled with the one or more antennas 815 that are configured to support various transmitting or outputting operations, or a combination thereof. In some implementations, the transceiver 810 may include or be configured for coupling with one or more processors or one or more memory components that are operable to perform or support operations based on received or obtained information or signals, or to generate information or other signals for transmission or other outputting, or any combination thereof. In some implementations, the transceiver 810, or the transceiver 810 and the one or more antennas 815, or the transceiver 810 and the one or more antennas 815 and one or more processors or one or more memory components (e.g., the at least one processor 835, the at least one memory 825, or both), may be included in a chip or chip assembly that is installed in the device 805. In some examples, the transceiver 810 may be operable to support communications via one or more communications links (e.g., communication link(s) 125, backhaul communication link(s) 120, a midhaul communication link 162, a fronthaul communication link 168).

The at least one memory 825 may include RAM, ROM, or any combination thereof. The at least one memory 825 may store computer-readable, computer-executable, or processor-executable code, such as the code 830. The code 830 may include instructions that, when executed by one or more of the at least one processor 835, cause the device 805 to perform various functions described herein. The code 830 may be stored in a non-transitory computer-readable medium such as system memory or another type of memory. In some cases, the code 830 may not be directly executable by a processor of the at least one processor 835 but may cause a computer (e.g., when compiled and executed) to perform functions described herein. In some cases, the at least one memory 825 may include, among other things, a BIOS which may control basic hardware or software operation such as the interaction with peripheral components or devices. In some examples, the at least one processor 835 may include multiple processors and the at least one memory 825 may include multiple memories. One or more of the multiple processors may be coupled with one or more of the multiple memories which may, individually or collectively, be configured to perform various functions herein (for example, as part of a processing system).

The at least one processor 835 may include one or more intelligent hardware devices (e.g., one or more general-purpose processors, one or more DSPs, one or more CPUs, one or more graphics processing units (GPUs), one or more neural processing units (NPUs) (also referred to as neural network processors or deep learning processors (DLPs)), one or more microcontrollers, one or more ASICs, one or more FPGAs, one or more programmable logic devices, discrete gate or transistor logic, one or more discrete hardware components, or any combination thereof). In some cases, the at least one processor 835 may be configured to operate a memory array using a memory controller. In some other cases, a memory controller may be integrated into one or more of the at least one processor 835. The at least one processor 835 may be configured to execute computer-readable instructions stored in a memory (e.g., one or more of the at least one memory 825) to cause the device 805 to perform various functions (e.g., functions or tasks supporting paging messages using NCRs). For example, the device 805 or a component of the device 805 may include at least one processor 835 and at least one memory 825 coupled with one or more of the at least one processor 835, the at least one processor 835 and the at least one memory 825 configured to perform various functions described herein. The at least one processor 835 may be an example of a cloud-computing platform (e.g., one or more physical nodes and supporting software such as operating systems, virtual machines, or container instances) that may host the functions (e.g., by executing code 830) to perform the functions of the device 805. The at least one processor 835 may be any one or more suitable processors capable of executing scripts or instructions of one or more software programs stored in the device 805 (such as within one or more of the at least one memory 825).

In some examples, the at least one processor 835 may include multiple processors and the at least one memory 825 may include multiple memories. One or more of the multiple processors may be coupled with one or more of the multiple memories, which may, individually or collectively, be configured to perform various functions herein. In some examples, the at least one processor 835 may be a component of a processing system, which may refer to a system (such as a series) of machines, circuitry (including, for example, one or both of processor circuitry (which may include the at least one processor 835) and memory circuitry (which may include the at least one memory 825)), or components, that receives or obtains inputs and processes the inputs to produce, generate, or obtain a set of outputs. The processing system may be configured to perform one or more of the functions described herein. For example, the at least one processor 835 or a processing system including the at least one processor 835 may be configured to, configurable to, or operable to cause the device 805 to perform one or more of the functions described herein. Further, as described herein, being “configured to,” being “configurable to,” and being “operable to” may be used interchangeably and may be associated with a capability, when executing code stored in the at least one memory 825 or otherwise, to perform one or more of the functions described herein.

In some examples, a bus 840 may support communications of (e.g., within) a protocol layer of a protocol stack. In some examples, a bus 840 may support communications associated with a logical channel of a protocol stack (e.g., between protocol layers of a protocol stack), which may include communications performed within a component of the device 805, or between different components of the device 805 that may be co-located or located in different locations (e.g., where the device 805 may refer to a system in which one or more of the communications manager 820, the transceiver 810, the at least one memory 825, the code 830, and the at least one processor 835 may be located in one of the different components or divided between different components).

In some examples, the communications manager 820 may manage aspects of communications with a core network 130 (e.g., via one or more wired or wireless backhaul links). For example, the communications manager 820 may manage the transfer of data communications for client devices, such as one or more UEs 115. In some examples, the communications manager 820 may manage communications with one or more other network entities 105, and may include a controller or scheduler for controlling communications with UEs 115 (e.g., in cooperation with the one or more other network devices). In some examples, the communications manager 820 may support an X2 interface within an LTE/LTE-A wireless communications network technology to provide communication between network entities 105.

The communications manager 820 may support wireless communications in accordance with examples as disclosed herein. For example, the communications manager 820 is capable of, configured to, or operable to support a means for outputting system information indicating a set of multiple paging occasions, where a first paging occasion of the set of multiple paging occasions is associated with a direct link between the network entity and a UE, and where a second paging occasion of the set of multiple paging occasions is associated with a link between the UE and a repeater. The communications manager 820 is capable of, configured to, or operable to support a means for outputting a set of multiple paging messages, each of the set of multiple paging messages associated with a corresponding one of the set of multiple paging occasions. The communications manager 820 is capable of, configured to, or operable to support a means for obtaining a message associated with a RACH procedure based on outputting the set of multiple paging messages.

Additionally, or alternatively, the communications manager 820 may support wireless communications in accordance with examples as disclosed herein. For example, the communications manager 820 is capable of, configured to, or operable to support a means for obtaining a control message indicating a paging configuration, the paging configuration including an indication of one or more SSBs and one or more paging messages associated with the one or more SSBs for the repeater to repeat. The communications manager 820 is capable of, configured to, or operable to support a means for obtaining the one or more SSBs and the one or more paging messages. The communications manager 820 is capable of, configured to, or operable to support a means for outputting the one or more SSBs and the one or more paging messages in accordance with the configuration.

By including or configuring the communications manager 820 in accordance with examples as described herein, the device 805 may support techniques for repeating paging messages using NCRs, which may result in improved communication reliability, reduced latency, reduced power consumption, more efficient utilization of communication resources, and improved coordination between devices.

In some examples, the communications manager 820 may be configured to perform various operations (e.g., receiving, obtaining, monitoring, outputting, transmitting) using or otherwise in cooperation with the transceiver 810, the one or more antennas 815 (e.g., where applicable), or any combination thereof. Although the communications manager 820 is illustrated as a separate component, in some examples, one or more functions described with reference to the communications manager 820 may be supported by or performed by the transceiver 810, one or more of the at least one processor 835, one or more of the at least one memory 825, the code 830, or any combination thereof (for example, by a processing system including at least a portion of the at least one processor 835, the at least one memory 825, the code 830, or any combination thereof). For example, the code 830 may include instructions executable by one or more of the at least one processor 835 to cause the device 805 to perform various aspects of paging messages using NCRs as described herein, or the at least one processor 835 and the at least one memory 825 may be otherwise configured to, individually or collectively, perform or support such operations.

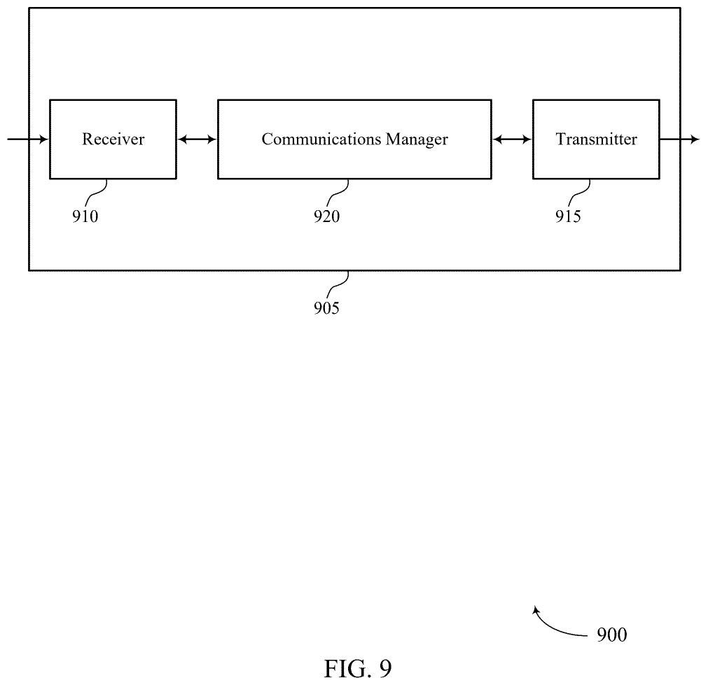

FIG. 9 shows a block diagram 900 of a device 905 that supports transmitting paging messages using NCRs in accordance with one or more aspects of the present disclosure. The device 905 may be an example of aspects of a UE 115 as described herein. The device 905 may include a receiver 910, a transmitter 915, and a communications manager 920. The device 905, or one or more components of the device 905 (e.g., the receiver 910, the transmitter 915, the communications manager 920), may include at least one processor, which may be coupled with at least one memory, to, individually or collectively, support or enable the described techniques. Each of these components may be in communication with one another (e.g., via one or more buses).

The receiver 910 may provide a means for receiving information such as packets, user data, control information, or any combination thereof associated with various information channels (e.g., control channels, data channels, information channels related to paging messages using NCRs). Information may be passed on to other components of the device 905. The receiver 910 may utilize a single antenna or a set of multiple antennas.

The transmitter 915 may provide a means for transmitting signals generated by other components of the device 905. For example, the transmitter 915 may transmit information such as packets, user data, control information, or any combination thereof associated with various information channels (e.g., control channels, data channels, information channels related to paging messages using NCRs). In some examples, the transmitter 915 may be co-located with a receiver 910 in a transceiver module. The transmitter 915 may utilize a single antenna or a set of multiple antennas.

The communications manager 920, the receiver 910, the transmitter 915, or various combinations or components thereof may be examples of means for performing various aspects of paging messages using NCRs as described herein. For example, the communications manager 920, the receiver 910, the transmitter 915, or various combinations or components thereof may be capable of performing one or more of the functions described herein.

In some examples, the communications manager 920, the receiver 910, the transmitter 915, or various combinations or components thereof may be implemented in hardware (e.g., in communications management circuitry). The hardware may include at least one of a processor, a digital signal processor (DSP), a central processing unit (CPU), an application-specific integrated circuit (ASIC), a field-programmable gate array (FPGA) or other programmable logic device, a microcontroller, discrete gate or transistor logic, discrete hardware components, or any combination thereof configured as or otherwise supporting, individually or collectively, a means for performing the functions described in the present disclosure. In some examples, at least one processor and at least one memory coupled with the at least one processor may be configured to perform one or more of the functions described herein (e.g., by one or more processors, individually or collectively, executing instructions stored in the at least one memory).

Additionally, or alternatively, the communications manager 920, the receiver 910, the transmitter 915, or various combinations or components thereof may be implemented in code (e.g., as communications management software or firmware) executed by at least one processor (e.g., referred to as a processor-executable code). If implemented in code executed by at least one processor, the functions of the communications manager 920, the receiver 910, the transmitter 915, or various combinations or components thereof may be performed by a general-purpose processor, a DSP, a CPU, an ASIC, an FPGA, a microcontroller, or any combination of these or other programmable logic devices (e.g., configured as or otherwise supporting, individually or collectively, a means for performing the functions described in the present disclosure).

In some examples, the communications manager 920 may be configured to perform various operations (e.g., receiving, obtaining, monitoring, outputting, transmitting) using or otherwise in cooperation with the receiver 910, the transmitter 915, or both. For example, the communications manager 920 may receive information from the receiver 910, send information to the transmitter 915, or be integrated in combination with the receiver 910, the transmitter 915, or both to obtain information, output information, or perform various other operations as described herein.

The communications manager 920 may support wireless communications in accordance with examples as disclosed herein. For example, the communications manager 920 is capable of, configured to, or operable to support a means for receiving system information indicating a set of multiple paging occasions, where a first paging occasion of the set of multiple paging occasions is associated with a direct link between the UE and a network entity, and where a second paging occasion of the set of multiple paging occasions is associated with a link between the UE and a repeater. The communications manager 920 is capable of, configured to, or operable to support a means for receiving one or more paging messages, each of the one or more paging messages associated with a corresponding one of the set of multiple paging occasions. The communications manager 920 is capable of, configured to, or operable to support a means for transmitting a message associated with a RACH procedure based on receiving the one or more paging messages.

By including or configuring the communications manager 920 in accordance with examples as described herein, the device 905 (e.g., at least one processor controlling or otherwise coupled with the receiver 910, the transmitter 915, the communications manager 920, or a combination thereof) may support techniques for repeating paging messages using NCRs, which may result in reduced power consumption and more efficient utilization of communication resources.

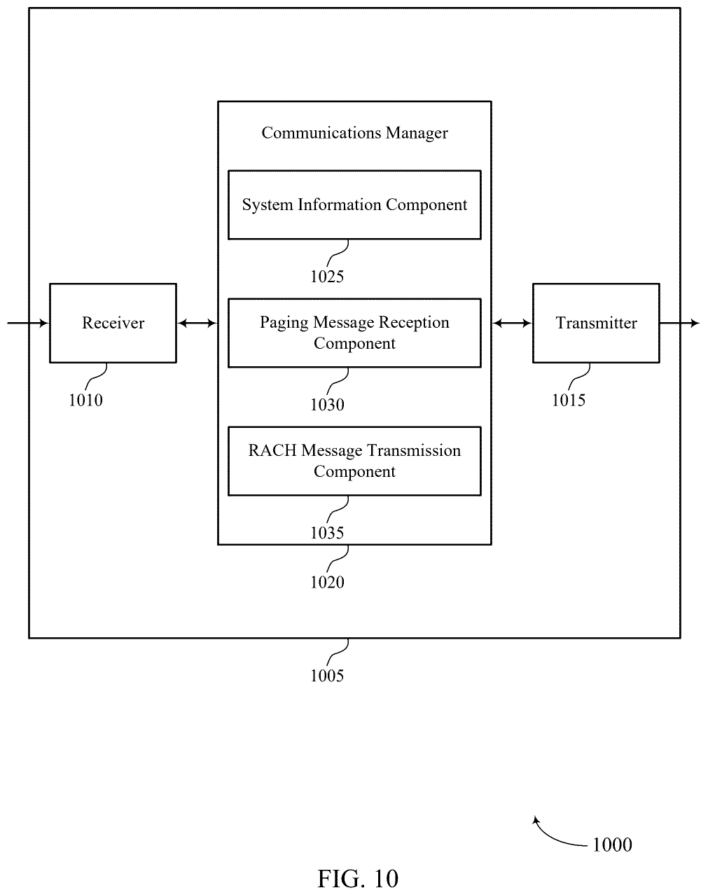

FIG. 10 shows a block diagram 1000 of a device 1005 that supports transmitting paging messages using NCRs in accordance with one or more aspects of the present disclosure. The device 1005 may be an example of aspects of a device 905 or a UE 115 as described herein. The device 1005 may include a receiver 1010, a transmitter 1015, and a communications manager 1020. The device 1005, or one or more components of the device 1005 (e.g., the receiver 1010, the transmitter 1015, the communications manager 1020), may include at least one processor, which may be coupled with at least one memory, to support the described techniques. Each of these components may be in communication with one another (e.g., via one or more buses).

The receiver 1010 may provide a means for receiving information such as packets, user data, control information, or any combination thereof associated with various information channels (e.g., control channels, data channels, information channels related to paging messages using NCRs). Information may be passed on to other components of the device 1005. The receiver 1010 may utilize a single antenna or a set of multiple antennas.

The transmitter 1015 may provide a means for transmitting signals generated by other components of the device 1005. For example, the transmitter 1015 may transmit information such as packets, user data, control information, or any combination thereof associated with various information channels (e.g., control channels, data channels, information channels related to paging messages using NCRs). In some examples, the transmitter 1015 may be co-located with a receiver 1010 in a transceiver module. The transmitter 1015 may utilize a single antenna or a set of multiple antennas.

The device 1005, or various components thereof, may be an example of means for performing various aspects of paging messages using NCRs as described herein. For example, the communications manager 1020 may include a system information component 1025, a paging message reception component 1030, a RACH message transmission component 1035, or any combination thereof. The communications manager 1020 may be an example of aspects of a communications manager 920 as described herein. In some examples, the communications manager 1020, or various components thereof, may be configured to perform various operations (e.g., receiving, obtaining, monitoring, outputting, transmitting) using or otherwise in cooperation with the receiver 1010, the transmitter 1015, or both. For example, the communications manager 1020 may receive information from the receiver 1010, send information to the transmitter 1015, or be integrated in combination with the receiver 1010, the transmitter 1015, or both to obtain information, output information, or perform various other operations as described herein.

The communications manager 1020 may support wireless communications in accordance with examples as disclosed herein. The system information component 1025 is capable of, configured to, or operable to support a means for receiving system information indicating a set of multiple paging occasions, where a first paging occasion of the set of multiple paging occasions is associated with a direct link between the UE and a network entity, and where a second paging occasion of the set of multiple paging occasions is associated with a link between the UE and a repeater. The paging message reception component 1030 is capable of, configured to, or operable to support a means for receiving one or more paging messages, each of the one or more paging messages associated with a corresponding one of the set of multiple paging occasions. The RACH message transmission component 1035 is capable of, configured to, or operable to support a means for transmitting a message associated with a RACH procedure based on receiving the one or more paging messages.

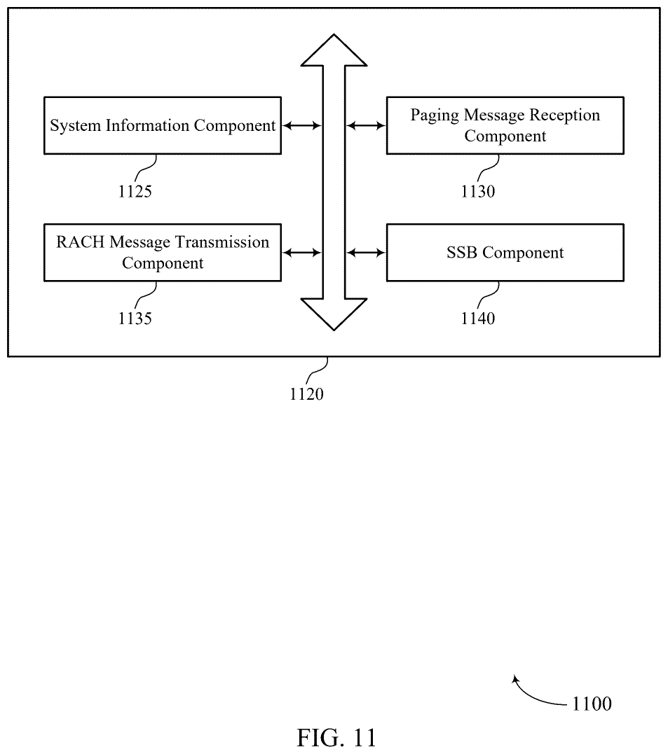

FIG. 11 shows a block diagram 1100 of a communications manager 1120 that supports transmitting paging messages using NCRs in accordance with one or more aspects of the present disclosure. The communications manager 1120 may be an example of aspects of a communications manager 920, a communications manager 1020, or both, as described herein. The communications manager 1120, or various components thereof, may be an example of means for performing various aspects of paging messages using NCRs as described herein. For example, the communications manager 1120 may include a system information component 1125, a paging message reception component 1130, a RACH message transmission component 1135, an SSB component 1140, or any combination thereof. Each of these components, or components or subcomponents thereof (e.g., one or more processors, one or more memories), may communicate, directly or indirectly, with one another (e.g., via one or more buses).

The communications manager 1120 may support wireless communications in accordance with examples as disclosed herein. The system information component 1125 is capable of, configured to, or operable to support a means for receiving system information indicating a set of multiple paging occasions, where a first paging occasion of the set of multiple paging occasions is associated with a direct link between the UE and a network entity, and where a second paging occasion of the set of multiple paging occasions is associated with a link between the UE and a repeater. The paging message reception component 1130 is capable of, configured to, or operable to support a means for receiving one or more paging messages, each of the one or more paging messages associated with a corresponding one of the set of multiple paging occasions. The RACH message transmission component 1135 is capable of, configured to, or operable to support a means for transmitting a message associated with a RACH procedure based on receiving the one or more paging messages.

In some examples, the SSB component 1140 is capable of, configured to, or operable to support a means for receiving a set of multiple SSBs, where receiving the set of multiple SSBs includes receiving one or more first SSBs via the direct link between the UE and the network entity and receiving one or more second SSBs via the link between the UE and the repeater. In some examples, the SSB component 1140 is capable of, configured to, or operable to support a means for performing a set of multiple power measurements associated with each of the set of multiple SSBs, where receiving the one or more paging messages is based on performing the set of multiple power measurements.

In some examples, to support receiving the one or more paging messages, the paging message reception component 1130 is capable of, configured to, or operable to support a means for receiving a first paging message via one of the direct link between the UE and the network entity or the link between the UE and the repeater based on the set of multiple power measurements.

In some examples, the SSB component 1140 is capable of, configured to, or operable to support a means for performing a second set of multiple power measurements associated with each of the set of multiple SSBs. In some examples, the paging message reception component 1130 is capable of, configured to, or operable to support a means for selecting one of the direct link between the UE and the network entity or the link between the UE and the repeater based on the second set of multiple power measurements, where receiving the first paging message includes receiving the first paging message via the selected one of the direct link between the UE and the network entity or the link between the UE and the repeater.

In some examples, to support receiving the one or more paging messages, the paging message reception component 1130 is capable of, configured to, or operable to support a means for receiving a first paging message during the first paging occasion via the direct link between the UE and the network entity. In some examples, to support receiving the one or more paging messages, the paging message reception component 1130 is capable of, configured to, or operable to support a means for receiving a second paging message during the second paging occasion via the link between the UE and the repeater, where the second paging occasion overlaps in time with the first paging occasion.

In some examples, to support receiving the one or more paging messages, the paging message reception component 1130 is capable of, configured to, or operable to support a means for receiving the one or more paging messages while the UE is in an idle state of a discontinuous reception mode of the UE.

In some examples, the first paging occasion overlaps in time with the second paging occasion.

In some examples, the first paging occasion does not overlap in time with the second paging occasion.

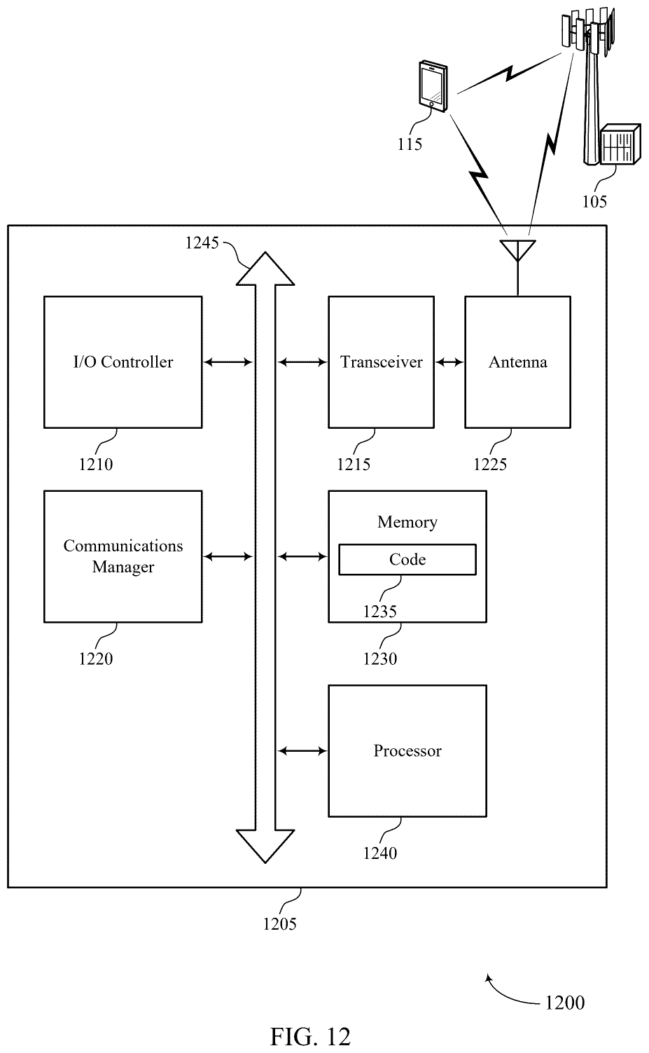

FIG. 12 shows a diagram of a system 1200 including a device 1205 that supports transmitting paging messages using NCRs in accordance with one or more aspects of the present disclosure. The device 1205 may be an example of or include components of a device 905, a device 1005, or a UE 115 as described herein. The device 1205 may communicate (e.g., wirelessly) with one or more other devices (e.g., network entities 105, UEs 115, or a combination thereof). The device 1205 may include components for bi-directional voice and data communications including components for transmitting and receiving communications, such as a communications manager 1220, an input/output (I/O) controller, such as an I/O controller 1210, a transceiver 1215, one or more antennas 1225, at least one memory 1230, code 1235, and at least one processor 1240. These components may be in electronic communication or otherwise coupled (e.g., operatively, communicatively, functionally, electronically, electrically) via one or more buses (e.g., a bus 1245).

The I/O controller 1210 may manage input and output signals for the device 1205. The I/O controller 1210 may also manage peripherals not integrated into the device 1205. In some cases, the I/O controller 1210 may represent a physical connection or port to an external peripheral. In some cases, the I/O controller 1210 may utilize an operating system such as iOS®, ANDROID®, MS-DOS®, MS-WINDOWS®, OS/2®, UNIX®, LINUX®, or another known operating system. Additionally, or alternatively, the I/O controller 1210 may represent or interact with a modem, a keyboard, a mouse, a touchscreen, or a similar device. In some cases, the I/O controller 1210 may be implemented as part of one or more processors, such as the at least one processor 1240. In some cases, a user may interact with the device 1205 via the I/O controller 1210 or via hardware components controlled by the I/O controller 1210.

In some cases, the device 1205 may include a single antenna. However, in some other cases, the device 1205 may have more than one antenna, which may be capable of concurrently transmitting or receiving multiple wireless transmissions. The transceiver 1215 may communicate bi-directionally via the one or more antennas 1225 using wired or wireless links as described herein. For example, the transceiver 1215 may represent a wireless transceiver and may communicate bi-directionally with another wireless transceiver. The transceiver 1215 may also include a modem to modulate the packets, to provide the modulated packets to one or more antennas 1225 for transmission, and to demodulate packets received from the one or more antennas 1225. The transceiver 1215, or the transceiver 1215 and one or more antennas 1225, may be an example of a transmitter 915, a transmitter 1015, a receiver 910, a receiver 1010, or any combination thereof or component thereof, as described herein.

The at least one memory 1230 may include random access memory (RAM) and read-only memory (ROM). The at least one memory 1230 may store computer-readable, computer-executable, or processor-executable code, such as the code 1235. The code 1235 may include instructions that, when executed by the at least one processor 1240, cause the device 1205 to perform various functions described herein. The code 1235 may be stored in a non-transitory computer-readable medium such as system memory or another type of memory. In some cases, the code 1235 may not be directly executable by the at least one processor 1240 but may cause a computer (e.g., when compiled and executed) to perform functions described herein. In some cases, the at least one memory 1230 may include, among other things, a basic I/O system (BIOS) which may control basic hardware or software operation such as the interaction with peripheral components or devices.

The at least one processor 1240 may include one or more intelligent hardware devices (e.g., one or more general-purpose processors, one or more DSPs, one or more CPUs, one or more graphics processing units (GPUs), one or more neural processing units (NPUs) (also referred to as neural network processors or deep learning processors (DLPs)), one or more microcontrollers, one or more ASICs, one or more FPGAs, one or more programmable logic devices, discrete gate or transistor logic, one or more discrete hardware components, or any combination thereof). In some cases, the at least one processor 1240 may be configured to operate a memory array using a memory controller. In some other cases, a memory controller may be integrated into the at least one processor 1240. The at least one processor 1240 may be configured to execute computer-readable instructions stored in a memory (e.g., the at least one memory 1230) to cause the device 1205 to perform various functions (e.g., functions or tasks supporting paging messages using NCRs). For example, the device 1205 or a component of the device 1205 may include at least one processor 1240 and at least one memory 1230 coupled with or to the at least one processor 1240, the at least one processor 1240 and the at least one memory 1230 configured to perform various functions described herein.

In some examples, the at least one processor 1240 may include multiple processors and the at least one memory 1230 may include multiple memories. One or more of the multiple processors may be coupled with one or more of the multiple memories, which may, individually or collectively, be configured to perform various functions described herein. In some examples, the at least one processor 1240 may be a component of a processing system, which may refer to a system (such as a series) of machines, circuitry (including, for example, one or both of processor circuitry (which may include the at least one processor 1240) and memory circuitry (which may include the at least one memory 1230)), or components, that receives or obtains inputs and processes the inputs to produce, generate, or obtain a set of outputs. The processing system may be configured to perform one or more of the functions described herein. For example, the at least one processor 1240 or a processing system including the at least one processor 1240 may be configured to, configurable to, or operable to cause the device 1205 to perform one or more of the functions described herein. Further, as described herein, being “configured to,” being “configurable to,” and being “operable to” may be used interchangeably and may be associated with a capability, when executing code 1235 (e.g., processor-executable code) stored in the at least one memory 1230 or otherwise, to perform one or more of the functions described herein.

The communications manager 1220 may support wireless communications in accordance with examples as disclosed herein. For example, the communications manager 1220 is capable of, configured to, or operable to support a means for receiving system information indicating a set of multiple paging occasions, where a first paging occasion of the set of multiple paging occasions is associated with a direct link between the UE and a network entity, and where a second paging occasion of the set of multiple paging occasions is associated with a link between the UE and a repeater. The communications manager 1220 is capable of, configured to, or operable to support a means for receiving one or more paging messages, each of the one or more paging messages associated with a corresponding one of the set of multiple paging occasions. The communications manager 1220 is capable of, configured to, or operable to support a means for transmitting a message associated with a RACH procedure based on receiving the one or more paging messages.

By including or configuring the communications manager 1220 in accordance with examples as described herein, the device 1205 may support techniques for repeating paging messages using NCRs, which may result in improved communication reliability, reduced latency, reduced power consumption, more efficient utilization of communication resources, and improved coordination between devices.

In some examples, the communications manager 1220 may be configured to perform various operations (e.g., receiving, monitoring, transmitting) using or otherwise in cooperation with the transceiver 1215, the one or more antennas 1225, or any combination thereof. Although the communications manager 1220 is illustrated as a separate component, in some examples, one or more functions described with reference to the communications manager 1220 may be supported by or performed by the at least one processor 1240, the at least one memory 1230, the code 1235, or any combination thereof. For example, the code 1235 may include instructions executable by the at least one processor 1240 to cause the device 1205 to perform various aspects of paging messages using NCRs as described herein, or the at least one processor 1240 and the at least one memory 1230 may be otherwise configured to, individually or collectively, perform or support such operations.

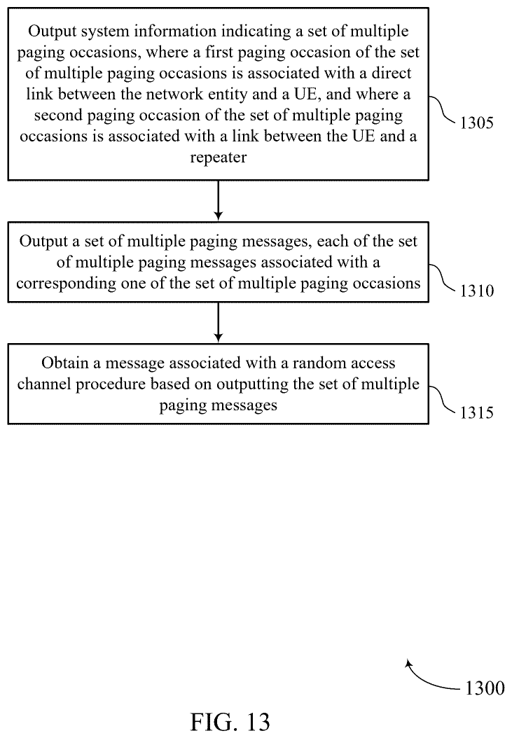

FIG. 13 shows a flowchart illustrating a method 1300 that supports transmitting paging messages using NCRs in accordance with one or more aspects of the present disclosure. The operations of the method 1300 may be implemented by a network entity or its components as described herein. For example, the operations of the method 1300 may be performed by a network entity as described with reference to FIGS. 1 through 8. In some examples, a network entity may execute a set of instructions to control the functional elements of the network entity to perform the described functions. Additionally, or alternatively, the network entity may perform aspects of the described functions using special-purpose hardware.

At 1305, the method may include outputting system information indicating a set of multiple paging occasions, where a first paging occasion of the set of multiple paging occasions is associated with a direct link between the network entity and a UE, and where a second paging occasion of the set of multiple paging occasions is associated with a link between the UE and a repeater. The operations of 1305 may be performed in accordance with examples as disclosed herein. In some examples, aspects of the operations of 1305 may be performed by a system information manager 725 as described with reference to FIG. 7.

At 1310, the method may include outputting a set of multiple paging messages, each of the set of multiple paging messages associated with a corresponding one of the set of multiple paging occasions. The operations of 1310 may be performed in accordance with examples as disclosed herein. In some examples, aspects of the operations of 1310 may be performed by a paging message transmission manager 730 as described with reference to FIG. 7.

At 1315, the method may include obtaining a message associated with a RACH procedure based on outputting the set of multiple paging messages. The operations of 1315 may be performed in accordance with examples as disclosed herein. In some examples, aspects of the operations of 1315 may be performed by a RACH message manager 735 as described with reference to FIG. 7.

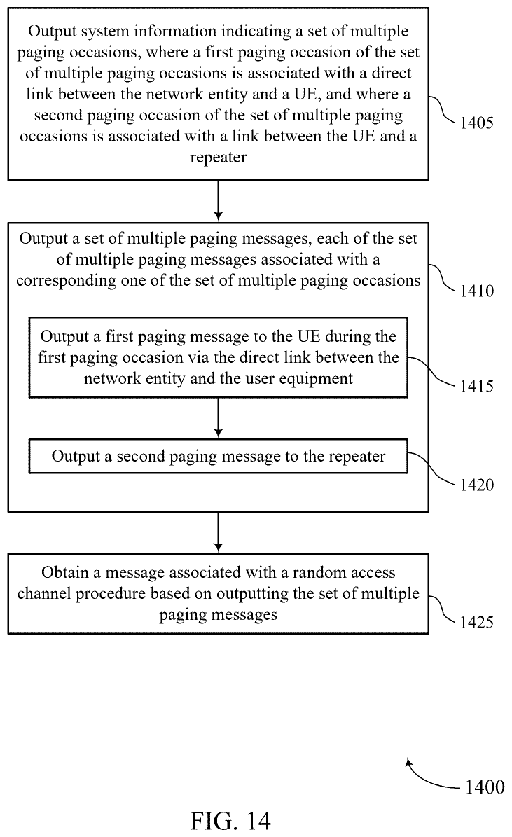

FIG. 14 shows a flowchart illustrating a method 1400 that supports transmitting paging messages using NCRs in accordance with one or more aspects of the present disclosure. The operations of the method 1400 may be implemented by a network entity or its components as described herein. For example, the operations of the method 1400 may be performed by a network entity as described with reference to FIGS. 1 through 8. In some examples, a network entity may execute a set of instructions to control the functional elements of the network entity to perform the described functions. Additionally, or alternatively, the network entity may perform aspects of the described functions using special-purpose hardware.

At 1405, the method may include outputting system information indicating a set of multiple paging occasions, where a first paging occasion of the set of multiple paging occasions is associated with a direct link between the network entity and a UE, and where a second paging occasion of the set of multiple paging occasions is associated with a link between the UE and a repeater. The operations of 1405 may be performed in accordance with examples as disclosed herein. In some examples, aspects of the operations of 1405 may be performed by a system information manager 725 as described with reference to FIG. 7.

At 1410, the method may include outputting a set of multiple paging messages, each of the set of multiple paging messages associated with a corresponding one of the set of multiple paging occasions. The operations of 1410 may be performed in accordance with examples as disclosed herein. In some examples, aspects of the operations of 1410 may be performed by a paging message transmission manager 730 as described with reference to FIG. 7.

Outputting a set of multiple paging messages may include, at 1415, outputting a first paging message to the UE during the first paging occasion via the direct link between the network entity and the user equipment. The operations of 1415 may be performed in accordance with examples as disclosed herein. In some examples, aspects of the operations of 1415 may be performed by a paging message transmission manager 730 as described with reference to FIG. 7.

Outputting a set of multiple paging messages may also include, at 1420, outputting a second paging message to the repeater. The operations of 1420 may be performed in accordance with examples as disclosed herein. In some examples, aspects of the operations of 1420 may be performed by a paging message transmission manager 730 as described with reference to FIG. 7.

At 1425, the method may include obtaining a message associated with a RACH procedure based on outputting the set of multiple paging messages. The operations of 1425 may be performed in accordance with examples as disclosed herein. In some examples, aspects of the operations of 1425 may be performed by a RACH message manager 735 as described with reference to FIG. 7.

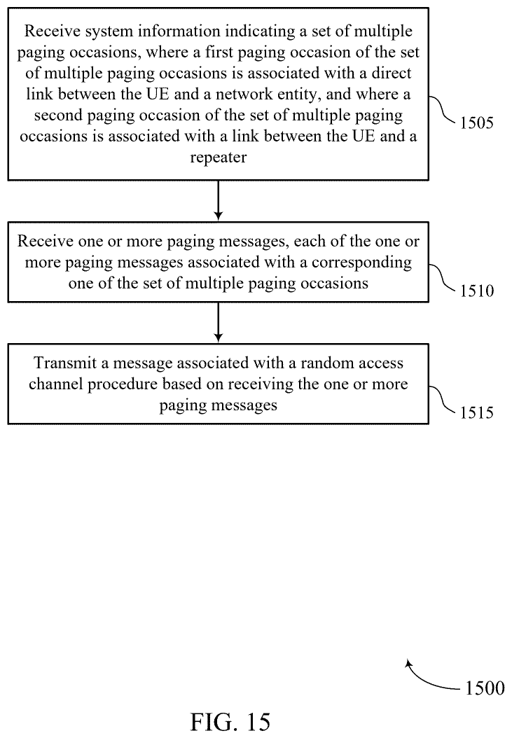

FIG. 15 shows a flowchart illustrating a method 1500 that supports transmitting paging messages using NCRs in accordance with one or more aspects of the present disclosure. The operations of the method 1500 may be implemented by a UE or its components as described herein. For example, the operations of the method 1500 may be performed by a UE 115 as described with reference to FIGS. 1 through 4 and 9 through 12. In some examples, a UE may execute a set of instructions to control the functional elements of the UE to perform the described functions. Additionally, or alternatively, the UE may perform aspects of the described functions using special-purpose hardware.

At 1505, the method may include receiving system information indicating a set of multiple paging occasions, where a first paging occasion of the set of multiple paging occasions is associated with a direct link between the UE and a network entity, and where a second paging occasion of the set of multiple paging occasions is associated with a link between the UE and a repeater. The operations of 1505 may be performed in accordance with examples as disclosed herein. In some examples, aspects of the operations of 1505 may be performed by a system information component 1125 as described with reference to FIG. 11.

At 1510, the method may include receiving one or more paging messages, each of the one or more paging messages associated with a corresponding one of the set of multiple paging occasions. The operations of 1510 may be performed in accordance with examples as disclosed herein. In some examples, aspects of the operations of 1510 may be performed by a paging message reception component 1130 as described with reference to FIG. 11.

At 1515, the method may include transmitting a message associated with a RACH procedure based on receiving the one or more paging messages. The operations of 1515 may be performed in accordance with examples as disclosed herein. In some examples, aspects of the operations of 1515 may be performed by a RACH message transmission component 1135 as described with reference to FIG. 11.

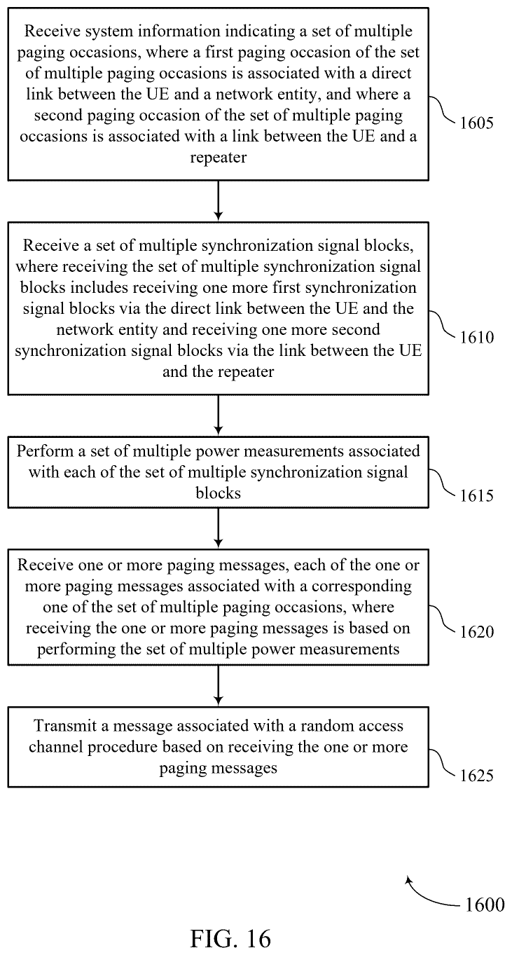

FIG. 16 shows a flowchart illustrating a method 1600 that supports transmitting paging messages using NCRs in accordance with one or more aspects of the present disclosure. The operations of the method 1600 may be implemented by a UE or its components as described herein. For example, the operations of the method 1600 may be performed by a UE 115 as described with reference to FIGS. 1 through 4 and 9 through 12. In some examples, a UE may execute a set of instructions to control the functional elements of the UE to perform the described functions. Additionally, or alternatively, the UE may perform aspects of the described functions using special-purpose hardware.

At 1605, the method may include receiving system information indicating a set of multiple paging occasions, where a first paging occasion of the set of multiple paging occasions is associated with a direct link between the UE and a network entity, and where a second paging occasion of the set of multiple paging occasions is associated with a link between the UE and a repeater. The operations of 1605 may be performed in accordance with examples as disclosed herein. In some examples, aspects of the operations of 1605 may be performed by a system information component 1125 as described with reference to FIG. 11.

At 1610, the method may include receiving a set of multiple SSBs, where receiving the set of multiple SSBs includes receiving one or more first SSBs via the direct link between the UE and the network entity and receiving one or more second SSBs via the link between the UE and the repeater. The operations of 1610 may be performed in accordance with examples as disclosed herein. In some examples, aspects of the operations of 1610 may be performed by an SSB component 1140 as described with reference to FIG. 11.

At 1615, the method may include performing a set of multiple power measurements associated with each of the set of multiple SSBs. The operations of 1615 may be performed in accordance with examples as disclosed herein. In some examples, aspects of the operations of 1615 may be performed by an SSB component 1140 as described with reference to FIG. 11.

At 1620, the method may include receiving one or more paging messages, each of the one or more paging messages associated with a corresponding one of the set of multiple paging occasions, where receiving the one or more paging messages is based on performing the set of multiple power measurements. The operations of 1620 may be performed in accordance with examples as disclosed herein. In some examples, aspects of the operations of 1620 may be performed by a paging message reception component 1130 as described with reference to FIG. 11.

At 1625, the method may include transmitting a message associated with a RACH procedure based on receiving the one or more paging messages. The operations of 1625 may be performed in accordance with examples as disclosed herein. In some examples, aspects of the operations of 1625 may be performed by a RACH message transmission component 1135 as described with reference to FIG. 11.

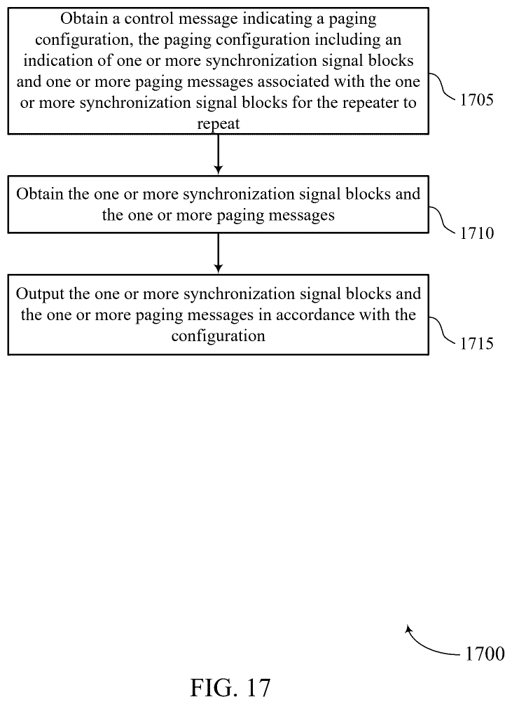

FIG. 17 shows a flowchart illustrating a method 1700 that supports transmitting paging messages using NCRs in accordance with one or more aspects of the present disclosure. The operations of the method 1700 may be implemented by a network entity or its components as described herein. For example, the operations of the method 1700 may be performed by a network entity as described with reference to FIGS. 1 through 8. In some examples, a network entity may execute a set of instructions to control the functional elements of the network entity to perform the described functions. Additionally, or alternatively, the network entity may perform aspects of the described functions using special-purpose hardware.

At 1705, the method may include obtaining a control message indicating a paging configuration, the paging configuration including an indication of one or more SSBs and one or more paging messages associated with the one or more SSBs for the repeater to repeat. The operations of 1705 may be performed in accordance with examples as disclosed herein. In some examples, aspects of the operations of 1705 may be performed by a paging configuration manager 740 as described with reference to FIG. 7.

At 1710, the method may include obtaining the one or more SSBs and the one or more paging messages. The operations of 1710 may be performed in accordance with examples as disclosed herein. In some examples, aspects of the operations of 1710 may be performed by an SSB manager 745 as described with reference to FIG. 7.

At 1715, the method may include outputting the one or more SSBs and the one or more paging messages in accordance with the configuration. The operations of 1715 may be performed in accordance with examples as disclosed herein. In some examples, aspects of the operations of 1715 may be performed by an SSB manager 745 as described with reference to FIG. 7.

The following provides an overview of aspects of the present disclosure:

Aspect 1: A method for wireless communications by a network entity, comprising: outputting system information indicating a plurality of paging occasions, wherein a first paging occasion of the plurality of paging occasions is associated with a direct link between the network entity and a UE, and wherein a second paging occasion of the plurality of paging occasions is associated with a link between the UE and a repeater; outputting a plurality of paging messages, each of the plurality of paging messages associated with a corresponding one of the plurality of paging occasions; and obtaining a message associated with a RACH procedure based at least in part on outputting the plurality of paging messages.

Aspect 2: The method of aspect 1, wherein outputting the plurality of paging messages comprises: outputting a first paging message to the UE during the first paging occasion via the direct link between the network entity and the UE; and outputting a second paging message to the repeater.

Aspect 3: The method of any of aspects 1 through 2, further comprising: outputting a control message indicating a paging configuration, the paging configuration comprising an indication of one or more SSBs and one or more paging messages of the plurality of paging messages for the repeater to repeat, wherein the one or more paging messages are associated with the one or more SSBs.

Aspect 4: The method of any of aspects 1 through 3, wherein outputting the plurality of paging messages comprises: outputting a capability request message comprising a request for buffering capability information associated with the repeater; and obtaining a capability message indicating a capability of the repeater to perform buffering in response to the capability request message.

Aspect 5: The method of aspect 4, further comprising: outputting a control message configuring the repeater to buffer a paging message of the plurality of paging messages based at least in part on the capability of the repeater to perform buffering, wherein first time resources associated with the first paging occasion do not overlap with second time resources associated with the second paging occasion.

Aspect 6: The method of any of aspects 4 through 5, wherein outputting the plurality of paging messages comprises: outputting a first paging message to the UE during the first paging occasion via the direct link between the network entity and the UE; and outputting a second paging message during the second paging occasion during the second paging occasion based at least in part on an inability of the repeater to perform buffering, wherein first time resources associated with the first paging occasion do not overlap with second time resources associated with the second paging occasion.

Aspect 7: The method of aspect 6, wherein outputting the plurality of paging messages comprises: outputting the first paging message via a first set of beams that are QCLed with a first subset of SSBs; and outputting the second paging message via a second set of beams that are QCLed with a second subset of SSBs based at least in part on the inability of the repeater to perform buffering.

Aspect 8: The method of any of aspects 1 through 4, wherein the first paging occasion overlaps in time with the second paging occasion.

Aspect 9: A method for wireless communications by a UE, comprising: receiving system information indicating a plurality of paging occasions, wherein a first paging occasion of the plurality of paging occasions is associated with a direct link between the UE and a network entity, and wherein a second paging occasion of the plurality of paging occasions is associated with a link between the UE and a repeater; receiving one or more paging messages, each of the one or more paging messages associated with a corresponding one of the plurality of paging occasions; and transmitting a message associated with a RACH procedure based at least in part on receiving the one or more paging messages.

Aspect 10: The method of aspect 9, further comprising: receiving a plurality of SSBs, wherein receiving the plurality of SSBs comprises receiving one more first SSBs via the direct link between the UE and the network entity and receiving one more second SSBs via the link between the UE and the repeater; and performing a plurality of power measurements associated with each of the plurality of SSBs, wherein receiving the one or more paging messages is based at least in part on performing the plurality of power measurements.

Aspect 11: The method of aspect 10, wherein receiving the one or more paging messages comprises: receiving a first paging message via one of the direct link between the UE and the network entity or the link between the UE and the repeater based at least in part on the plurality of power measurements.

Aspect 12: The method of aspect 11, further comprising: performing a second plurality of power measurements associated with each of the plurality of SSBs; and selecting one of the direct link between the UE and the network entity or the link between the UE and the repeater based at least in part on the second plurality of power measurements, wherein receiving the first paging message comprises receiving the first paging message via the selected one of the direct link between the UE and the network entity or the link between the UE and the repeater.

Aspect 13: The method of any of aspects 9 through 12, wherein receiving the one or more paging messages comprises: receiving a first paging message during the first paging occasion via the direct link between the UE and the network entity; and receiving a second paging message during the second paging occasion via the link between the UE and the repeater, wherein the second paging occasion overlaps in time with the first paging occasion.

Aspect 14: The method of any of aspects 9 through 13, wherein receiving the one or more paging messages comprises: receiving the one or more paging messages while the UE is in an idle state of a discontinuous reception mode of the UE.

Aspect 15: The method of any of aspects 9 through 14, wherein the first paging occasion overlaps in time with the second paging occasion.

Aspect 16: The method of any of aspects 9 through 12 and 14, wherein the first paging occasion does not overlap in time with the second paging occasion.

Aspect 17: A method for wireless communications by a repeater, comprising: obtaining a control message indicating a paging configuration, the paging configuration comprising an indication of one or more SSBs and one or more paging messages associated with the one or more SSBs for the repeater to repeat; obtaining the one or more SSBs and the one or more paging messages; and outputting the one or more SSBs and the one or more paging messages in accordance with the configuration.

Aspect 18: The method of aspect 17, further comprising: performing a frequency translation on the one or more SSBs and the one or more paging messages in accordance with the configuration; and outputting the one or more SSBs and the one or more paging messages via a second frequency band, wherein obtaining the one or more SSBs and the one or more paging messages comprises obtaining the one or more SSBs and the one or more paging messages via a first frequency band that is different from the second frequency band in accordance with the frequency translation.

Aspect 19: The method of any of aspects 17 through 18, further comprising: obtaining a capability request message comprising a request for buffering capability information associated with the repeater; and outputting a capability message indicating a capability of the repeater to perform buffering in response to the capability request message.

Aspect 20: The method of aspect 19, wherein the control message indicates for the repeater to buffer the one or more paging messages based at least in part on the capability of the repeater to perform buffering.

Aspect 21: A network entity for wireless communications, comprising one or more memories storing processor-executable code, and one or more processors coupled with the one or more memories and individually or collectively operable to execute the code to cause the network entity to perform a method of any of aspects 1 through 8.

Aspect 22: A network entity for wireless communications, comprising at least one means for performing a method of any of aspects 1 through 8.

Aspect 23: A non-transitory computer-readable medium storing code for wireless communications, the code comprising instructions executable by one or more processors to perform a method of any of aspects 1 through 8.

Aspect 24: A UE for wireless communications, comprising one or more memories storing processor-executable code, and one or more processors coupled with the one or more memories and individually or collectively operable to execute the code to cause the UE to perform a method of any of aspects 9 through 16.

Aspect 25: A UE for wireless communications, comprising at least one means for performing a method of any of aspects 9 through 16.

Aspect 26: A non-transitory computer-readable medium storing code for wireless communications, the code comprising instructions executable by one or more processors to perform a method of any of aspects 9 through 16.

Aspect 27: A repeater for wireless communications, comprising one or more memories storing processor-executable code, and one or more processors coupled with the one or more memories and individually or collectively operable to execute the code to cause the repeater to perform a method of any of aspects 17 through 20.

Aspect 28: A repeater for wireless communications, comprising at least one means for performing a method of any of aspects 17 through 20.

Aspect 29: A non-transitory computer-readable medium storing code for wireless communications, the code comprising instructions executable by one or more processors to perform a method of any of aspects 17 through 20.

It should be noted that the methods described herein describe possible implementations. The operations and the steps may be rearranged or otherwise modified and other implementations are possible. Further, aspects from two or more of the methods may be combined.

Although aspects of an LTE, LTE-A, LTE-A Pro, or NR system may be described for purposes of example, and LTE, LTE-A, LTE-A Pro, or NR terminology may be used in much of the description, the techniques described herein are applicable beyond LTE, LTE-A, LTE-A Pro, or NR networks. For example, the described techniques may be applicable to various other wireless communications systems such as Ultra Mobile Broadband (UMB), Institute of Electrical and Electronics Engineers (IEEE) 802.11 (Wi-Fi), IEEE 802.16 (WiMAX), IEEE 802.20, Flash-OFDM, as well as other systems and radio technologies not explicitly mentioned herein.

Information and signals described herein may be represented using any of a variety of different technologies and techniques. For example, data, instructions, commands, information, signals, bits, symbols, and chips that may be referenced throughout the description may be represented by voltages, currents, electromagnetic waves, magnetic fields or particles, optical fields or particles, or any combination thereof.

The various illustrative blocks and components described in connection with the disclosure herein may be implemented or performed using a general-purpose processor, a DSP, an ASIC, a CPU, a graphics processing unit (GPU), a neural processing unit (NPU), an FPGA or other programmable logic device, discrete gate or transistor logic, discrete hardware components, or any combination thereof designed to perform the functions described herein. A general-purpose processor may be a microprocessor but, in the alternative, the processor may be any processor, controller, microcontroller, or state machine. A processor may also be implemented as a combination of computing devices (e.g., a combination of a DSP and a microprocessor, multiple microprocessors, one or more microprocessors in conjunction with a DSP core, or any other such configuration). Any functions or operations described herein as being capable of being performed by a processor may be performed by multiple processors that, individually or collectively, are capable of performing the described functions or operations.

The functions described herein may be implemented using hardware, software executed by a processor, firmware, or any combination thereof. If implemented using software executed by a processor, the functions may be stored as or transmitted using one or more instructions or code of a computer-readable medium. Other examples and implementations are within the scope of the disclosure and appended claims. For example, due to the nature of software, functions described herein may be implemented using software executed by a processor, hardware, firmware, hardwiring, or combinations of any of these. Features implementing functions may also be physically located at various positions, including being distributed such that portions of functions are implemented at different physical locations.

Computer-readable media includes both non-transitory computer storage media and communication media including any medium that facilitates transfer of a computer program from one location to another. A non-transitory storage medium may be any available medium that may be accessed by a general-purpose or special-purpose computer. By way of example, and not limitation, non-transitory computer-readable media may include RAM, ROM, electrically erasable programmable ROM (EEPROM), flash memory, compact disk (CD) ROM or other optical disk storage, magnetic disk storage or other magnetic storage devices, or any other non-transitory medium that may be used to carry or store desired program code means in the form of instructions or data structures and that may be accessed by a general-purpose or special-purpose computer or a general-purpose or special-purpose processor. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of computer-readable medium. Disk and disc, as used herein, include CD, laser disc, optical disc, digital versatile disc (DVD), floppy disk, and Blu-ray disc. Disks may reproduce data magnetically, and discs may reproduce data optically using lasers. Combinations of the above are also included within the scope of computer-readable media. Any functions or operations described herein as being capable of being performed by a memory may be performed by multiple memories that, individually or collectively, are capable of performing the described functions or operations.

As used herein, including in the claims, “or” as used in a list of items (e.g., a list of items prefaced by a phrase such as “at least one of” or “one or more of”) indicates an inclusive list such that, for example, a list of at least one of A, B, or C means A or B or C or AB or AC or BC or ABC (i.e., A and B and C). Also, as used herein, the phrase “based on” shall not be construed as a reference to a closed set of conditions. For example, an example step that is described as “based on condition A” may be based on both a condition A and a condition B without departing from the scope of the present disclosure. In other words, as used herein, the phrase “based on” shall be construed in the same manner as the phrase “based at least in part on.”

As used herein, including in the claims, the article “a” before a noun is open-ended and understood to refer to “at least one” of those nouns or “one or more” of those nouns. Thus, the terms “a,” “at least one,” “one or more,” and “at least one of one or more” may be interchangeable. For example, if a claim recites “a component” that performs one or more functions, each of the individual functions may be performed by a single component or by any combination of multiple components. Thus, the term “a component” having characteristics or performing functions may refer to “at least one of one or more components” having a particular characteristic or performing a particular function. Subsequent reference to a component introduced with the article “a” using the terms “the” or “said” may refer to any or all of the one or more components. For example, a component introduced with the article “a” may be understood to mean “one or more components,” and referring to “the component” subsequently in the claims may be understood to be equivalent to referring to “at least one of the one or more components.” Similarly, subsequent reference to a component introduced as “one or more components” using the terms “the” or “said” may refer to any or all of the one or more components. For example, referring to “the one or more components” subsequently in the claims may be understood to be equivalent to referring to “at least one of the one or more components.”

The term “determine” or “determining” encompasses a variety of actions and, therefore, “determining” can include calculating, computing, processing, deriving, investigating, looking up (such as via looking up in a table, a database, or another data structure), ascertaining, and the like. Also, “determining” can include receiving (e.g., receiving information), accessing (e.g., accessing data stored in memory), and the like. Also, “determining” can include resolving, obtaining, selecting, choosing, establishing, and other such similar actions.

In the appended figures, similar components or features may have the same reference label. Further, various components of the same type may be distinguished by following the reference label by a dash and a second label that distinguishes among the similar components. If just the first reference label is used in the specification, the description is applicable to any one of the similar components having the same first reference label irrespective of the second reference label or other subsequent reference label.

The description set forth herein, in connection with the appended drawings, describes example configurations and does not represent all the examples that may be implemented or that are within the scope of the claims. The term “example” used herein means “serving as an example, instance, or illustration” and not “preferred” or “advantageous over other examples.” The detailed description includes specific details for the purpose of providing an understanding of the described techniques. These techniques, however, may be practiced without these specific details. In some figures, known structures and devices are shown in block diagram form in order to avoid obscuring the concepts of the described examples.

The description herein is provided to enable a person having ordinary skill in the art to make or use the disclosure. Various modifications to the disclosure will be apparent to a person having ordinary skill in the art, and the generic principles defined herein may be applied to other variations without departing from the scope of the disclosure. Thus, the disclosure is not limited to the examples and designs described herein but is to be accorded the broadest scope consistent with the principles and novel features disclosed herein.

What is claimed is:

1. A network entity, comprising:
one or more memories storing processor-executable code; and
one or more processors coupled with the one or more memories and individually or collectively operable to execute the code to cause the network entity to:
output system information indicating a plurality of paging occasions, wherein a first paging occasion of the plurality of paging occasions is associated with a direct link between the network entity and a user equipment (UE), and wherein a second paging occasion of the plurality of paging occasions is associated with a link between the UE and a repeater;
output a plurality of paging messages, each of the plurality of paging messages associated with a corresponding one of the plurality of paging occasions; and
obtain a message associated with a random access channel procedure based at least in part on outputting the plurality of paging messages.

2. The network entity of claim 1, wherein, to output the plurality of paging messages, the one or more processors are individually or collectively operable to execute the code to cause the network entity to:
output a first paging message to the UE during the first paging occasion via the direct link between the network entity and the user equipment; and
output a second paging message to the repeater.

3. The network entity of claim 1, wherein the one or more processors are individually or collectively further operable to execute the code to cause the network entity to:
output a control message indicating a paging configuration, the paging configuration comprising an indication of one or more synchronization signal blocks and one or more paging messages of the plurality of paging messages for the repeater to repeat, wherein the one or more paging messages are associated with the one or more synchronization signal blocks.

4. The network entity of claim 1, wherein, to output the plurality of paging messages, the one or more processors are individually or collectively operable to execute the code to cause the network entity to:
output a capability request message comprising a request for buffering capability information associated with the repeater; and
obtain a capability message indicating a capability of the repeater to perform buffering in response to the capability request message.

5. The network entity of claim 4, wherein the one or more processors are individually or collectively further operable to execute the code to cause the network entity to:
output a control message configuring the repeater to buffer a paging message of the plurality of paging messages based at least in part on the capability of the repeater to perform buffering, wherein first time resources associated with the first paging occasion do not overlap with second time resources associated with the second paging occasion.

6. The network entity of claim 4, wherein, to output the plurality of paging messages, the one or more processors are individually or collectively operable to execute the code to cause the network entity to:
output a first paging message to the UE during the first paging occasion via the direct link between the network entity and the user equipment; and
output a second paging message during the second paging occasion based at least in part on an inability of the repeater to perform buffering, wherein first time resources associated with the first paging occasion do not overlap with second time resources associated with the second paging occasion.

7. The network entity of claim 6, wherein, to output the plurality of paging messages, the one or more processors are individually or collectively operable to execute the code to cause the network entity to:
output the first paging message via a first set of beams that are quasi co-located with a first subset of synchronization signal blocks; and
output the second paging message via a second set of beams that are quasi co-located with a second subset of synchronization signal blocks based at least in part on the inability of the repeater to perform buffering.

8. The network entity of claim 1, wherein the first paging occasion overlaps in time with the second paging occasion.

9. A user equipment (UE), comprising:
one or more memories storing processor-executable code; and
one or more processors coupled with the one or more memories and individually or collectively operable to execute the code to cause the UE to:
receive system information indicating a plurality of paging occasions, wherein a first paging occasion of the plurality of paging occasions is associated with a direct link between the UE and a network entity, and wherein a second paging occasion of the plurality of paging occasions is associated with a link between the UE and a repeater;
receive one or more paging messages, each of the one or more paging messages associated with a corresponding one of the plurality of paging occasions; and
transmit a message associated with a random access channel procedure based at least in part on receiving the one or more paging messages.

10. The UE of claim 9, wherein the one or more processors are individually or collectively further operable to execute the code to cause the UE to:
receive a plurality of synchronization signal blocks, wherein, to receive the plurality of synchronization signal blocks, the one or more processors are individually or collectively operable to execute the code to cause the UE to receive one or more first synchronization signal blocks via the direct link between the UE and the network entity and receive one or more second synchronization signal blocks via the link between the UE and the repeater; and
perform a plurality of power measurements associated with each of the plurality of synchronization signal blocks, wherein the one or more processors are individually or collectively operable to execute the code to cause the UE to receive the one or more paging messages based at least in part on performing the plurality of power measurements.

11. The UE of claim 10, wherein, to receive the one or more paging messages, the one or more processors are individually or collectively operable to execute the code to cause the UE to:
receive a first paging message via one of the direct link between the UE and the network entity or the link between the UE and the repeater based at least in part on the plurality of power measurements.

12. The UE of claim 11, wherein the one or more processors are individually or collectively further operable to execute the code to cause the UE to:
perform a second plurality of power measurements associated with each of the plurality of synchronization signal blocks; and
select one of the direct link between the UE and the network entity or the link between the UE and the repeater based at least in part on the second plurality of power measurements, wherein the one or more processors are individually or collectively operable to execute the code to cause the UE to receive the first paging message via the selected one of the direct link between the UE and the network entity or the link between the UE and the repeater.

13. The UE of claim 9, wherein, to receive the one or more paging messages, the one or more processors are individually or collectively operable to execute the code to cause the UE to:
receive a first paging message during the first paging occasion via the direct link between the UE and the network entity; and
receive a second paging message during the second paging occasion via the link between the UE and the repeater, wherein the second paging occasion overlaps in time with the first paging occasion.

14. The UE of claim 9, wherein, to receive the one or more paging messages, the one or more processors are individually or collectively operable to execute the code to cause the UE to:
receive the one or more paging messages while the UE is in an idle state of a discontinuous reception mode of the UE.

15. The UE of claim 9, wherein the first paging occasion overlaps in time with the second paging occasion.

16. The UE of claim 9, wherein the first paging occasion does not overlap in time with the second paging occasion.

17. A repeater, comprising:
one or more memories storing processor-executable code; and
one or more processors coupled with the one or more memories and individually or collectively operable to execute the code to cause the repeater to:
obtain a control message indicating a paging configuration, the paging configuration comprising an indication of one or more synchronization signal blocks and one or more paging messages associated with the one or more synchronization signal blocks for the repeater to repeat;
obtain the one or more synchronization signal blocks and the one or more paging messages; and
output the one or more synchronization signal blocks and the one or more paging messages in accordance with the paging configuration.

18. The repeater of claim 17, wherein the one or more processors are individually or collectively further operable to execute the code to cause the repeater to:
perform a frequency translation on the one or more synchronization signal blocks and the one or more paging messages in accordance with the paging configuration; and
output the one or more synchronization signal blocks and the one or more paging messages via a second frequency band, wherein the one or more processors are individually or collectively operable to execute the code to cause the repeater to obtain the one or more synchronization signal blocks and the one or more paging messages via a first frequency band that is different from the second frequency band in accordance with the frequency translation.

19. The repeater of claim 17, wherein the one or more processors are individually or collectively further operable to execute the code to cause the repeater to:
obtain a capability request message comprising a request for buffering capability information associated with the repeater; and
output a capability message indicating a capability of the repeater to perform buffering in response to the capability request message.

20. The repeater of claim 19, wherein the control message indicates for the repeater to buffer the one or more paging messages based at least in part on the capability of the repeater to perform buffering.
